(19) United States
(12) Patent Application Publication
(10) Pub. No.: US 2022/0266379 A1
(43) Pub. Date: Aug. 25, 2022

(54) LASER PROCESSING DEVICE

(71) Applicant: Nuvoton Technology Corporation Japan, Kyoto (JP)

(72) Inventor: Shinji YOSHIDA, Shiga (JP)

(21) Appl. No.: 17/740,737

(22) Filed: May 10, 2022

Related U.S. Application Data
(63) Continuation of application No. PCT/JP2020/041786, filed on Nov. 9, 2020.

(30) Foreign Application Priority Data
Nov. 13, 2019 (JP) 2019-205117

(51) Int. Cl. B23K 26/03; G01N 21/31

(52) U.S. Cl. CPC B23K 26/032; G01N 21/31; B23K 26/323

(57) ABSTRACT

A laser processing device includes: a first laser oscillator that emits a first laser beam having a peak wavelength of a first wavelength; a second laser oscillator that emits a second laser beam having a peak wavelength of a second wavelength different than the first wavelength; a drive controller that drives each of the first laser oscillator and the second laser oscillator; and an analyzer that obtains signal light from a workpiece and adjusts one or more processing conditions for the workpiece based on the obtained signal light. The drive controller drives the first laser oscillator and the second laser oscillator according to the one or more processing conditions to change an intensity of at least one of the first laser beam or the second laser beam and irradiate the workpiece with at least one of the first laser beam or the second laser beam.

### CROSS REFERENCE TO RELATED APPLICATIONS

This application is a continuation under 35 U.S.C. § 111(a) of of International Application No. PCT/JP2020/041786, filed on Nov. 9, 2020, designating the United States of America, which in turn claims the benefit of Japanese Patent Application No. 2019-205117, filed on Nov. 13, 2019, the entire disclosures of the above-identified applications, including the specifications, drawings, and claims are incorporated herein by reference in their entirety.

### FIELD

The present disclosure relates to a laser processing device, in particular to a laser processing device that processes a composite material made of two or more types of materials with a laser beam.

### BACKGROUND

One example of a conventionally known laser processing device that processes an object by laser irradiation is a laser processing device that can emit laser beams of different wavelengths so that the laser processing device can switch between the laser beams in accordance with different materials that the object is made of. For example, Patent Literature (PTL) 1 discloses, in FIG. 1, a multi-wavelength laser emitting device including, as light sources to be used in this type of laser processing device, a semiconductor laser element that emits a red laser beam and a semiconductor laser element that emits an infrared laser beam.

### CITATION LIST

### Patent Literature

PTL 1: Japanese Unexamined Patent Application Publication No. 2001-249556

### SUMMARY

### Technical Problem

When placing a workpiece on a processing table and laser processing the workpiece, it is possible to irradiate a predetermined processing position on the workpiece with a laser beam by determining the placement position at which to place the workpiece on the processing table in advance. This enables laser processing with high throughput and low spattering of the material of the workpiece by the laser irradiation (i.e., this enables high quality laser processing).

However, for example, if the workpiece is misaligned with the predetermined placement position when it is placed on the processing table or if there are individual differences (individual variations) between workpieces due to variations in the external shape of the workpieces, the determined processing position of the workpiece will not be irradiated with the appropriate laser beam, leading to processing defects.

In particular, when the workpiece is a composite material made of two or more types of materials, the wavelength of the laser beam may be switched at points where the material changes. In such cases, if the workpiece is misaligned, each of the materials in the composite material will not be irradiated with the laser beam of the appropriate wavelength, resulting in processing defects. This results in lower processing quality and lower throughput.

The present disclosure was conceived to overcome such problems, and has an object to provide a laser processing device and the like that can realize high quality laser processing with high throughput.

### Solution to Problem

In order to achieve the above object, a laser processing device according to one aspect of the present disclosure processes an object using a laser beam and includes: a first laser oscillator that emits a first laser beam having a peak wavelength of a first wavelength; a second laser oscillator that emits a second laser beam having a peak wavelength of a second wavelength different than the first wavelength; a drive controller that drives each of the first laser oscillator and the second laser oscillator; and an analyzer that obtains signal light from the object and adjusts one or more processing conditions for the object based on the signal light obtained. The drive controller drives the first laser oscillator and the second laser oscillator according to the one or more processing conditions to change an intensity of at least one of the first laser beam or the second laser beam and irradiate the object with at least one of the first laser beam or the second laser beam.

### Advantageous Effects

The present disclosure achieves high quality laser processing with high throughput.

### BRIEF DESCRIPTION OF DRAWINGS

These and other advantages and features will become apparent from the following description thereof taken in conjunction with the accompanying Drawings, by way of non-limiting examples of embodiments disclosed herein.

In FIG. 1, (a) is for illustrating the irradiation of a composite material with a laser beam by a laser processing device to process the composite material, and (b) is a plan view of the state illustrated in (a) in an XY coordinate system of the laser processing device.

FIG. 2 illustrates the occurrence of a positional misalignment of the composite material when laser processing the composite material using a predetermined recipe.

FIG. 3 is a block diagram illustrating the configuration of a laser processing device according to Embodiment 1.

FIG. 4 is a flowchart of a laser processing method according to Embodiment 1.

FIG. 5 is a block diagram illustrating the configuration of a laser processing device according to Embodiment 2.

FIG. 6 is a flowchart of a laser processing method according to Embodiment 2.

FIG. 7 is a block diagram illustrating the configuration of a laser processing device according to Embodiment 3.

FIG. 8 is a flowchart of a laser processing method according to Embodiment 3.

FIG. 9 is a block diagram illustrating the configuration of a laser processing device according to Embodiment 4.

FIG. 10 is a flowchart of a laser processing method according to Embodiment 4.

FIG. 11 illustrates one example of a reflection spectrum obtained from signal light from a workpiece according to Embodiment 4.

FIG. 12 illustrates one example of a data set of reflection spectrums stored in a database according to Embodiment 4.

FIG. 13 is a block diagram illustrating the configuration of a laser processing device according to Embodiment 5.

FIG. 14 illustrates one example of a two-dimensional image captured by an image sensor according to Embodiment 5.

FIG. 15 is a flowchart of a laser processing method according to Embodiment 5.

FIG. 16 illustrates one example of a layout of a single pixel in the image sensor according to Embodiment 5.

FIG. 17 illustrates another example of a layout of a single pixel in the image sensor according to Embodiment 5.

FIG. 18 illustrates one example of a reflection spectrum corresponding to a spectral pixel according to Embodiment 5.

FIG. 19 is a block diagram illustrating the configuration of a laser processing device according to Embodiment 6.

FIG. 20 is a flowchart of a laser processing method according to Embodiment 6.

FIG. 21 illustrates one example of emission light intensity relative to processing depth as captured by an image sensor according to Embodiment 6.

FIG. 22 is a block diagram illustrating the configuration of a laser processing device according to a variation.

### DESCRIPTION OF EMBODIMENTS

### Underlying Knowledge Forming the Basis of an Aspect of the Present Disclosure

First, before describing embodiments of the present disclosure, the underlying knowledge forming the basis of an aspect of the present disclosure will be described.

When performing laser processing on a composite material made of two or more types of materials, since the absorption rate of light differs depending on the material, it is conceivable to perform the laser processing using a laser processing device that can emit laser beams of different wavelengths, and switch the wavelength of the laser beam at points where the material changes. For example, consider a case in which two pieces of composite material 2X are overlapped to be welded together, as illustrated in (a) and (b) in FIG. 1. Here, each piece of composite material 2X includes first part 2a made of a first material and second part 2b made of a second material different than the first material, and first part 2a and second part 2b are connected side by side in a plan view. In this example, the two pieces of composite material 2X are to be welded together by irradiating the linear welding area, which is the predetermined processing position, with a laser beam so that the two first parts 2a are welded together and the two second parts 2b are welded together. In this case, since the absorption rate of light of first part 2a differs from the absorption rate of light of second part 2b, the part of the welding area corresponding to first part 2a is irradiated with first laser beam L1 having a wavelength suitable for the first material of first part 2a, and the part of the welding area corresponding to second part 2b is irradiated with second laser beam L2 having a wavelength suitable for the second material of second part 2b. More specifically, when composite material 2X is a sheet or plate of a composite metal material, the first material of first part 2a is aluminum, and the second material of second part 2b is copper, since aluminum has a high absorption rate of infrared light and copper has a high absorption rate of blue light, first laser beam L1 is an infrared laser beam and second laser beam L2 is a blue laser beam. Here, the position at which the lasers are to be switched is set to the boundary between first part 2a and second part 2b, and the laser beam that irradiates composite material 2X is switched from first laser beam L1 to second laser beam L2 at this position.

When laser processing a workpiece using this method, by pre-preparing processing conditions (hereinafter also referred to as a “recipe”), such as information indicating which materials are positioned where and which laser beam is to be used in the laser irradiation, it is possible to select the laser beam having the appropriate wavelength for each material in a given position in which different materials are present. For example, as illustrated in (b) in FIG. 1, when welding two pieces of composite material 2X placed on a processing table together by laser irradiation using a laser processing device, the welding area and the laser conditions for composite material 2X are pre-prepared in advance as a recipe by, in the XY coordinate system used by the laser processing device (or laser processing system), (i) determining in advance the placement position at which the two pieces of composite material 2X are to be placed on the processing table, (ii) determining in advance the range of coordinates for the welding area from a position at which both first part 2a and second part 2b are present, and (iii) determining in advance a laser condition that switches the laser beam that irradiates composite material 2X from first laser beam L1 to second laser beam L2 at the boundary between first part 2a and second part 2b as laser switching coordinates. This makes it possible to irradiate first part 2a and second part 2b, which are made of different materials, with a laser beam suitable for each material since it is possible to switch the laser beam that irradiates composite material 2X from first laser beam L1 to second laser beam L2 at the laser switching coordinates. This enables laser processing with high throughput and low spattering (i.e., high quality laser processing).

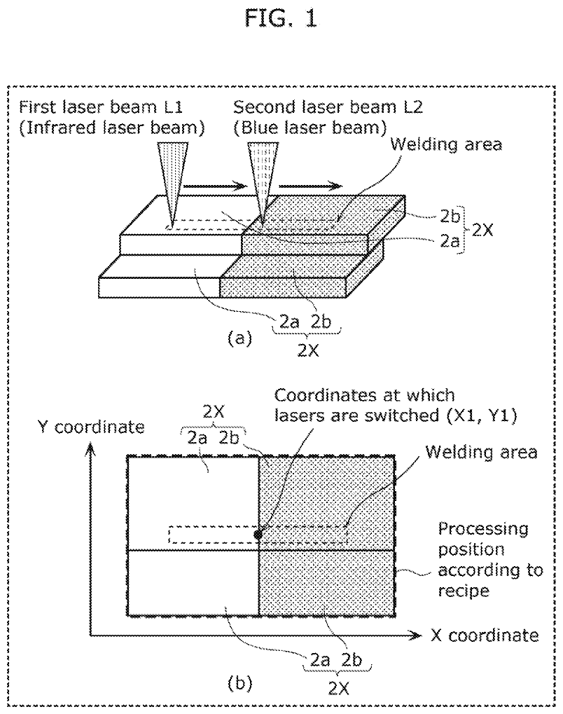

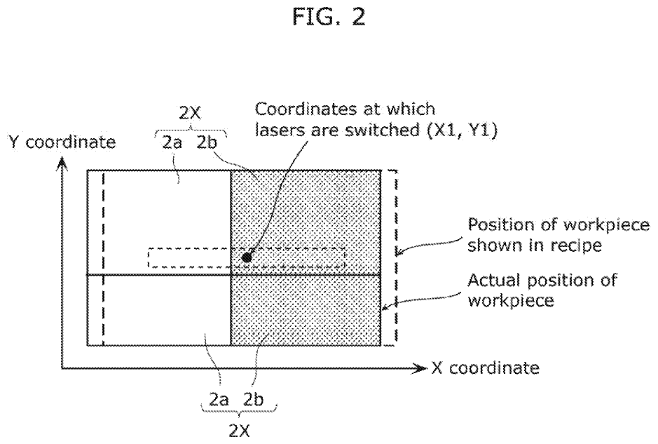

However, due to, for example, variations in the placement of a workpiece or depending on the positioning accuracy of the laser processing device, the workpiece may be misaligned with the predetermined placement position when it is placed on the processing table, and there may be individual differences (individual variations) between workpieces due to variations in the external shape of the workpieces. For example, as illustrated in FIG. 2, if a coordinate misalignment occurs due to the position of the workpiece being misaligned as a result of composite material 2X, which is the workpiece, being placed on the processing table out of alignment with the placement position determined in advance by the recipe or due to individual differences between workpieces resulting from variations in the external shape of the workpieces, when the laser beam is switched at the laser switching coordinates determined in advance by the recipe, the laser beam is not switched at the boundary between first part 2a and second part 2b, but rather switched at a different position than the boundary between first part 2a and second part 2b. For example, in FIG. 2, the position of composite material 2X is displaced in the negative X-axis direction, resulting in the laser switching coordinates indicated by the recipe being displaced in the positive X-axis direction. As a result, when processing composite material 2X by scanning the laser beam from first part 2a to second part 2b, the laser beam that actually irradiates composite material 2X is switched above second part 2b after passing the boundary between first part 2a and second part 2b. As a result, all of the welding area in first part 2a is irradiated with the laser beam of the appropriate wavelength, but the welding area in second part 2b includes a portion irradiated with a laser beam not of the appropriate wavelength. More specifically, the portion of second part 2b between the actual boundary of first and second parts 2a and 2b and the predetermined laser switching coordinates is irradiated with first laser beam L1, which is suitable for first part 2a. As a result, the entire welding area (processing position) of composite material 2X cannot be irradiated with the laser beams of the appropriate wavelengths.

In this way, with a method involving pre-preparing a recipe (processing conditions) determined in advance before the laser processing is performed, when the workpiece is misaligned or the like, the predetermined processing position of the workpiece cannot be irradiated with a laser beam. This results in processing defects in the workpiece which lowers processing quality and thus lowers throughput.

For example, in order to avoid variations in the coordinates at which the wavelength of the laser beam is switched, it is necessary to measure variations in the external shape of individual workpieces and the placement position of individual workpieces, and create, for each individual workpiece, individual recipes that appropriately correspond to the coordinates at which the wavelength of the laser beam is to be switched, which consequently lowers throughput.

The present disclosure was conceived to overcome such problems, and has an object to provide a laser processing device and the like that can realize high quality laser processing with high throughput, even when laser processing a composite material.

Hereinafter, embodiments will be described with reference to the drawings. Each of the following embodiments shows a specific example of the present disclosure. The numerical values, shapes, materials, elements, the arrangement and connection of the elements, steps, order of the steps, etc., indicated in the following embodiments are mere examples, and therefore do not intend to limit the present disclosure.

The figures are schematic illustrations and are not necessarily precise depictions. Accordingly, the figures are not necessarily to scale. In the figures, elements that are essentially the same share like reference signs. Accordingly, duplicate description is omitted or simplified.

### Embodiment 1

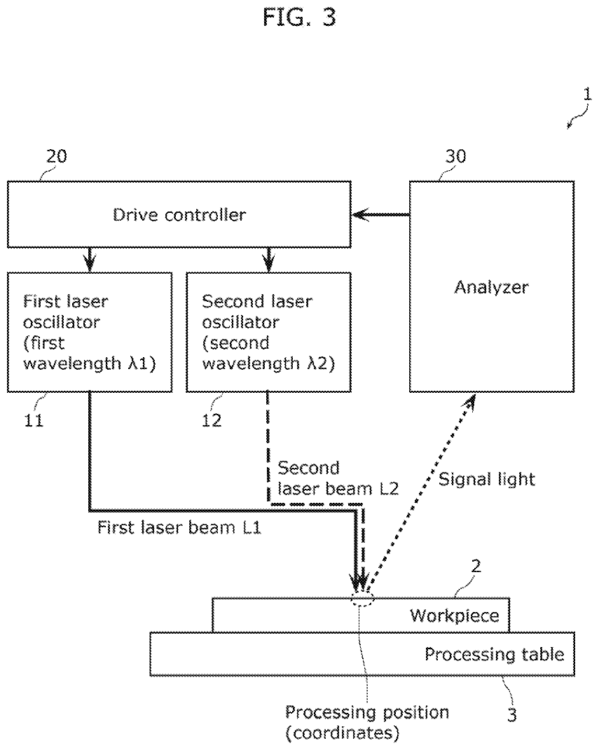

First, the configuration of laser processing device 1 according to Embodiment 1 will be described with reference to FIG. 3. FIG. 3 is a block diagram illustrating the configuration of laser processing device 1 according to Embodiment 1.

As illustrated in FIG. 3, laser processing device 1 is a device that processes workpiece 2 using a laser beam. Stated differently, laser processing device 1 performs laser processing on workpiece 2 by emitting a laser beam toward workpiece 2 and irradiating workpiece 2 with the laser beam. The laser processing performed by laser processing device 1 is, for example, welding, cutting, or drilling or the like.

Workpiece 2 is the object to be processed by laser processing device 1. Stated differently, workpiece 2 is the object to be irradiated by the laser beam. In the present embodiment, workpiece 2 is composite material 2X illustrated in FIG. 1, and is placed on processing table 3.

Processing table 3 is a stage on which workpiece 2 is placed. Processing table 3 is configured to be moveable in the X-axis and Y-axis directions, which are two mutually orthogonal directions. Processing table 3 may further be configured to be moveable in the Z-axis direction (for example, the vertical direction) orthogonal to both the X- and Y-axes, or to rotate around a predetermined 0-axis.

As illustrated in FIG. 3, laser processing device 1 includes first laser oscillator 11, second laser oscillator 12, drive controller 20, and analyzer 30.

First laser oscillator 11 emits, as a laser beam for processing workpiece 2, first laser beam L1 having a peak wavelength of a first wavelength (λ1). Second laser oscillator 12 emits, as a laser beam for processing workpiece 2, second laser beam L2 having a peak wavelength of a second wavelength (λ2) different than the first wavelength (λ2≠λ1). For example, each of first laser oscillator 11 and second laser oscillator 12 includes a semiconductor laser element that emits a laser beam.

In the present embodiment, the second wavelength of second laser beam L2 emitted by second laser oscillator 12 is shorter than the first wavelength of first laser beam L1 emitted by first laser oscillator 11 (λ1>λ2).

As one example, the first wavelength of first laser beam L1 is a wavelength in the near-infrared range or longer. More specifically, the first wavelength of first laser beam L1 is a wavelength of 800 nm or longer. As one example, the second wavelength of second laser beam L2 is a wavelength in the visible light range or shorter. More specifically, the second wavelength of second laser beam L2 is a wavelength of 800 nm or shorter.

For example, as illustrated in FIG. 1, when workpiece 2 is composite material 2X that includes first part 2a made of a first material, aluminum, and second part 2b made of a second material, copper, since aluminum has a high absorption rate of infrared light and copper has a high absorption rate of blue light, first laser beam L1 may be an infrared laser beam and second laser beam L2 may be a blue laser beam. The combination of materials in composite material 2X is not limited to aluminum and copper, and may be a combination of aluminum and gold or nickel. The combination of materials in composite material 2X can be any combination of dissimilar metals with different absorption rates of light.

First laser beam L1 emitted from first laser oscillator 11 irradiates workpiece 2 placed on processing table 3. Similarly, second laser beam L2 emitted from second laser oscillator 12 irradiates workpiece 2 placed on processing table 3. More specifically, first laser beam L1 and second laser beam L2 irradiate a processing position on workpiece 2. An appropriate lens, mirror, or other optical system may be provided to guide and condense the laser beam toward the processing position.

Drive controller 20 drives each of first laser oscillator 11 and second laser oscillator 12.

More specifically, drive controller 20 can drive first laser oscillator 11 so as to turn first laser oscillator 11 on to cause first laser oscillator 11 to emit first laser beam L1, and turn first laser oscillator 11 off to cause first laser oscillator 11 to not emit first laser beam L1. Stated differently, drive controller 20 can drive first laser oscillator 11 so as to start and stop the emission of first laser beam L1. Drive controller 20 can further drive first laser oscillator 11 so as to change the intensity (output power) of first laser beam L1.

Similarly, drive controller 20 can drive second laser oscillator 12 so as to turn second laser oscillator 12 on to cause second laser oscillator 12 to emit second laser beam L2, and turn second laser oscillator 12 off to cause second laser oscillator 12 to not emit second laser beam L2. Stated differently, drive controller 20 can drive second laser oscillator 12 so as to start and stop the emission of second laser beam L2. Drive controller 20 can further drive second laser oscillator 12 so as to change the intensity (output power) of second laser beam L2.

Analyzer 30 obtains signal light from workpiece 2 and adjusts the processing conditions for workpiece 2 based on the obtained signal light. More specifically, analyzer 30 obtains material information about the material of workpiece 2 by analyzing the signal light obtained from workpiece 2, and adjusts the processing conditions (laser processing conditions) for laser processing workpiece 2 based on the obtained material information. For example, analyzer 30 includes a mechanism such as a photodetector that receives signal light from workpiece 2, and a control device such as a control circuit for adjusting the processing conditions for workpiece 2 according to the intensity of the received signal light.

As one example, when workpiece 2 is composite material 2X, analyzer 30 obtains material information indicating that first part 2a includes a first material by analyzing the signal light from first part 2a, and adjusts the processing conditions for laser processing first part 2a of workpiece 2 based on the obtained material information. More specifically, analyzer 30 adjusts the processing conditions by selecting first laser beam L1 as the laser beam suitable for the first material of first part 2a of workpiece 2 and further setting the intensity of first laser beam L1. Similarly, analyzer 30 obtains material information indicating that second part 2b includes a second material by analyzing the signal light from second part 2b, and adjusts the processing conditions for laser processing second part 2b of workpiece 2 based on the obtained material information. More specifically, analyzer 30 adjusts the processing conditions by selecting second laser beam L2 as the laser beam suitable for the second material of second part 2b of workpiece 2 and further setting the intensity of second laser beam L2.

In laser processing device 1 according to the present embodiment, drive controller 20 drives first laser oscillator 11 and second laser oscillator 12 according to the processing conditions obtained by analyzer 30 to change the intensity of at least one of first laser beam L1 or second laser beam L2 and irradiate workpiece 2 with at least one of first laser beam L1 or second laser beam L2.

More specifically, drive controller 20 changes the intensity of each of first laser beam L1 and second laser beam L2 according to the processing conditions for workpiece 2 adjusted based on the material information about workpiece 2 obtained by analyzing the signal light from workpiece 2 using analyzer 30, and selectively irradiates workpiece 2 with first laser beam L1 and second laser beam L2. Stated differently, drive controller 20 switches between the laser beams so as to irradiate workpiece 2 with the laser beam that is suitable for the material of workpiece 2 according to the material information about workpiece 2 obtained by analyzer 30. Here, drive controller 20 controls the driving of first laser oscillator 11 and second laser oscillator 12 so as to switch the laser beam that irradiates workpiece 2 from first laser beam L1 to second laser beam L2 or from second laser beam L2 to first laser beam L1.

For example, when workpiece 2 is composite material 2X and the part to be laser processed is first part 2a, since first laser beam L1 is selected and its intensity is adjusted by analyzer 30 as processing conditions suitable for the first material of first part 2a, drive controller 20 drives first laser oscillator 11 so as to turn first laser oscillator 11 on and drives second laser oscillator 12 so as to turn second laser oscillator 12 off so that first laser beam L1 suitable for the first material of first part 2a irradiates first part 2a according to the processing conditions adjusted by analyzer 30. Similarly, when the part to be laser processed is second part 2b, since second laser beam L2 is selected and its intensity is adjusted by analyzer 30 as the processing conditions suitable for the second material of second part 2b, drive controller 20 drives second laser oscillator 12 so as to turn second laser oscillator 12 on and drives first laser oscillator 11 so as to turn first laser oscillator 11 off so that second laser beam L2 suitable for the second material of second part 2b irradiates second part 2b according to the processing conditions adjusted by analyzer 30.

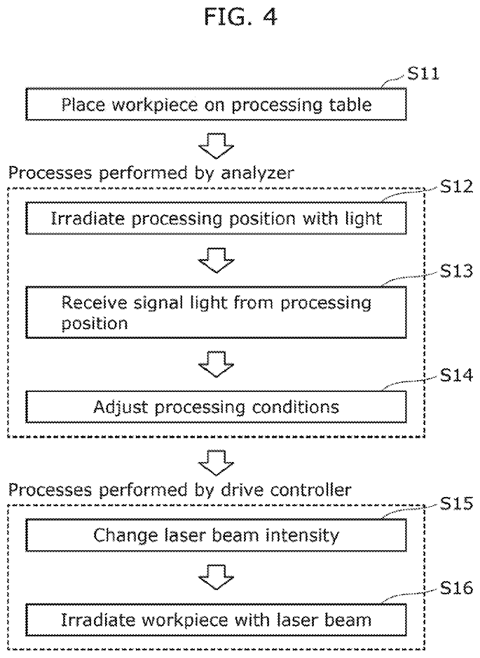

Next, the laser processing method according to the present embodiment that uses laser processing device 1 will be described with reference to FIG. 3 and FIG. 4. FIG. 4 is a flowchart of the laser processing method according to Embodiment 1.

As illustrated in FIG. 4, first, workpiece 2 is placed on processing table 3 (step S11). More specifically, workpiece 2 to be laser processed by laser processing device 1 is placed on processing table 3. For example, when two workpieces 2 are to be welded together by irradiating the processing position of workpiece 2 with a laser beam using laser processing device 1, the processing position of workpiece 2 is the welding area.

Next, the processing position of workpiece 2 is irradiated with light (step S12). For example, the processing position of workpiece 2 is irradiated with a light for receiving signal light from the processing position of workpiece 2. For example, workpiece 2 is irradiated with a laser beam, LED light, or illumination light or the like. Step S12 is performed by analyzer 30. Analyzer 30 therefore includes a mechanism that irradiates the processing position of workpiece 2 with light.

Next, the signal light from the processing position of workpiece 2 is received (step S13). For example, the reflected light of the light that irradiates the processing position of workpiece 2 is received as the signal light. Step S13 can be performed using, for example, the photodetector included in analyzer 30.

Next, the processing conditions for performing the laser processing are adjusted according to the received signal light (step S14). More specifically, the intensity (output power) of first laser beam L1 emitted from first laser oscillator 11 and the intensity (output power) of second laser beam L2 emitted from second laser oscillator 12 are determined as processing conditions. Step S14 can be performed using, for example, the control device included in analyzer 30.

Next, laser beam intensity is changed based on the adjusted processing conditions (step S15). More specifically, the intensity of at least one of first laser beam L1 emitted from first laser oscillator 11 and second laser beam L2 emitted from second laser oscillator 12 is changed according to the processing conditions adjusted in step S14. Step S15 is performed by drive controller 20.

Next, workpiece 2 is irradiated by laser beam (step S16). More specifically, first laser beam L1 is emitted from first laser oscillator 11 and irradiates the processing position of workpiece 2 at the intensity set in step S15 and/or second laser beam L2 is emitted from second laser oscillator 12 and irradiates the processing position of workpiece 2 at the intensity set in step S15. Step S16 is performed by drive controller 20.

The laser processing method according to the present embodiment can be performed by following the above steps. Doing so allows for completion of the laser processing with only having to perform the sequence of steps S13 to S16 once. More specifically, first, steps S13 and S14 are performed to obtain the signal light of all processing positions of workpiece 2 and adjust the processing conditions for all of the processing positions of workpiece 2, and then steps S15 and S16 are performed based on the adjusted processing conditions to irradiate workpiece 2 with first laser beam L1 and second laser beam L2 to perform the laser processing. Stated differently, a recipe of processing conditions for all processing positions of workpiece 2 is created first, and then laser processing is performed based on the created recipe.

Instead of performing the sequence of steps S13 to S16 only once, the sequence of steps S13 to S16 may be repeatedly performed. Stated differently, the laser processing may be performed by repeating the sequence of steps S13 to S16 at each of the processing positions of workpiece 2. For example, at a given processing position on workpiece 2, steps S13 and S14 are performed to obtain the signal light of the processing position of workpiece 2 and adjust the processing conditions for workpiece 2 (to create a recipe), and then steps S15 and S16 are performed based on the adjusted processing conditions (recipe) to irradiate workpiece 2 with first laser beam L1 and second laser beam L2 to perform the laser processing. Next, at another processing position on workpiece 2, steps S13 and S14 are performed to obtain the signal light of the processing position of workpiece 2 and adjust the processing conditions for workpiece 2, and then steps S15 and S16 are performed based on the adjusted processing conditions to irradiate workpiece 2 with first laser beam L1 and second laser beam L2 to perform the laser processing. Thereafter, other processing positions are processed sequentially in the same manner. In this way, the laser processing may be performed in real time by creating the processing conditions as the signal light is obtained at the processing positions of workpiece 2.

With laser processing device 1 according to the present embodiment, analyzer 30 obtains the signal light from workpiece 2 and adjusts the processing conditions for workpiece 2 based on the obtained signal light, and drive controller 20 drives first laser oscillator 11 and second laser oscillator 12 according to the adjusted processing conditions to change the intensity of at least one of first laser beam L1 or second laser beam L2 and irradiate workpiece 2 with at least one of first laser beam L1 or second laser beam L2.

In this way, with laser processing device 1 according to the present embodiment, signal light obtained from workpiece 2 is analyzed to obtain material information about workpiece 2, the processing conditions are adjusted according to the obtained material information, and first laser oscillator 11 and second laser oscillator 12 are driven according to the adjusted processing conditions.

This allows the processing position of workpiece 2 to be selectively irradiated with first laser beam L1 and second laser beam L2 based on processing conditions suitable for the material of workpiece 2. In particular, laser processing device 1 according to the present embodiment adjusts the processing conditions for each workpiece 2 even if a positional misalignment of workpiece 2 occurs or a coordinate misalignment of workpiece 2 due to individual differences between workpieces 2 occurs. Stated differently, instead of processing workpiece 2 with a single recipe created in advance, the recipe can be corrected (or adjusted) according to the actual workpiece 2 placed on processing table 3. Furthermore, the material of the workpiece can be identified and the wavelength of the laser beam to be used for processing can be selected according to the actual workpiece 2 placed on processing table 3 without creating a recipe in advance before placing workpiece 2 on processing table 3. This allows for proper laser processing at a predetermined processing position on workpiece 2, regardless of the coordinate position of workpiece 2. Therefore, even if workpiece 2 to be processed is composite material 2X, laser processing can be performed at each processing position of first part 2a and second part 2b using processing conditions suitable for the respective materials of first part 2a and second part 2b. This achieves high quality laser processing with high throughput.

Moreover, in laser processing device 1 according to the present embodiment, drive controller 20 drives first laser oscillator 11 and second laser oscillator 12 according to the processing conditions adjusted by analyzer 30 to cause first laser oscillator 11 and second laser oscillator 12 to emit one of first laser beam L1 and second laser beam L2 and not emit the other of first laser beam L1 and second laser beam L2.

This allows first laser oscillator 11 or second laser oscillator 12, whichever is more suitable for laser processing according to the material information about workpiece 2 obtained from analyzer 30, to be selectively driven. This achieves high quality laser processing.

In laser processing device 1 according to the present embodiment, the first wavelength of first laser beam L1 is a wavelength in the near-infrared range or longer.

With this configuration, first laser beam L1 can inhibit heat generation and spattering caused by scattered light when laser processing materials such as aluminum and certain resins, since the absorption rate of these materials to light in the infrared range is high. This achieves even higher quality laser processing.

In laser processing device 1 according to the present embodiment, the second wavelength of second laser beam L2 is a wavelength in the visible light range or shorter.

With this configuration, second laser beam L2 can inhibit heat generation and spattering caused by scattered light when laser processing high-reflectance materials such as metal or organic materials such as resin, since the absorption rate of these materials to second laser beam L2 is high. This achieves even higher quality laser processing.

### Embodiment 2

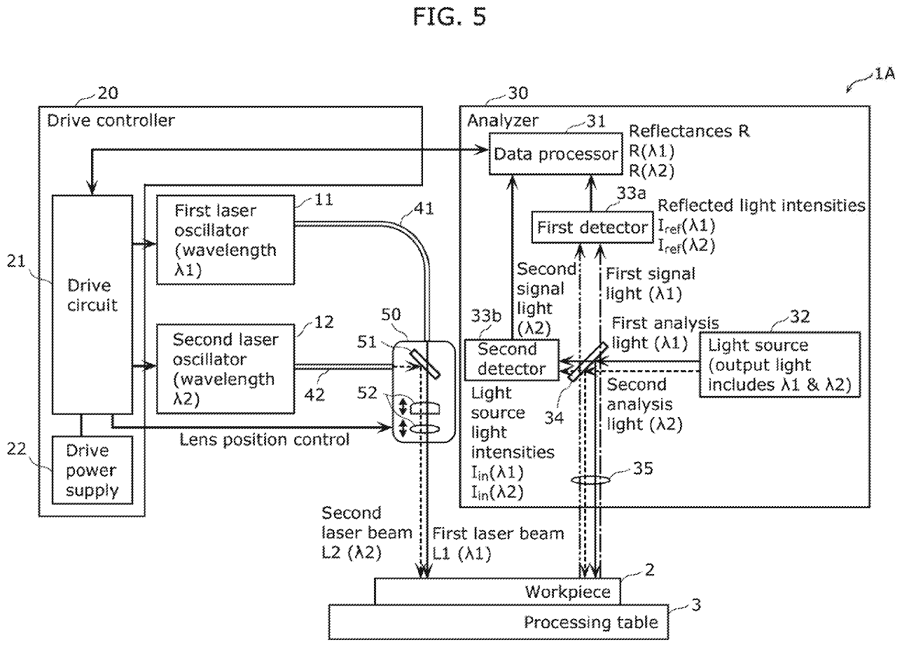

First, the configuration of laser processing device 1A according to Embodiment 2 will be described with reference to FIG. 5. FIG. 5 is a block diagram illustrating the configuration of laser processing device 1A according to Embodiment 2.

As illustrated in FIG. 5, just like laser processing device 1 according to Embodiment 1 described above, laser processing device 1A according to the present embodiment includes first laser oscillator 11, second laser oscillator 12, drive controller 20, and analyzer 30. Laser processing device 1A according to the present embodiment is a more specific configuration of laser processing device 1 according to Embodiment 1 described above.

In the present embodiment, drive controller 20 includes drive circuit 21 and drive power supply 22. Drive controller 20 according to the present embodiment has the same functions as described in Embodiment 1.

Drive circuit 21 is a control circuit that controls the driving of each of first laser oscillator 11 and second laser oscillator 12 according to the analysis result of analyzer 30. More specifically, drive circuit 21 controls the driving for turning on and off first laser oscillator 11 and second laser oscillator 12, and controls the intensity of each of first laser beam L1 emitted from first laser oscillator 11 and second laser beam L2 emitted from second laser oscillator 12.

Drive power supply 22 is a power supply that generates power for driving drive circuit 21. For example, drive power supply 22 converts power from an external input power supply into a predetermined power for driving drive circuit 21.

Analyzer 30 adjusts the processing conditions corresponding to the coordinates of the processing position of workpiece 2 obtained when the signal light from workpiece 2 is obtained. Drive controller 20 drives first laser oscillator 11 and second laser oscillator 12 according to these processing conditions to irradiate workpiece 2 with at least one of first laser beam L1 or second laser beam L2 based on the coordinates of the processing position of workpiece 2.

In the present embodiment, analyzer 30 includes data processor 31, light source 32, first detector 33a, second detector 33b, beam splitter 34, and lens 35.

Data processor 31 analyzes the signal light from workpiece 2. Data processor 31 adjusts the processing conditions corresponding to the coordinates of the processing position of workpiece 2 based on the signal light from workpiece 2. In the present embodiment, the signal light from workpiece 2 is at least part of the analysis light emitted from light source 32 and reflected by the surface of workpiece 2.

Light emitted from light source 32 irradiates the processing position of workpiece 2 as analysis light via beam splitter 34 and lens 35. Beam splitter 34 and lens 35 are an example of the optical system that irradiates the processing position of workpiece 2 with the analysis light.

Beam splitter 34 reflects the light emitted from light source 32 onto lens 35. Lens 35 is a condenser lens that condenses the light emitted from light source 32 and reflected by beam splitter 34, and irradiates the processing position of workpiece 2 with the emitted light. The condenser lens is, for example, a focusing lens such as a convex lens that focuses the light and/or a collimator lens that collimates the light. In other words, not only may the processing position be irradiated using a focusing lens, the processing position may be irradiated with collimated light using a collimator lens.

Note that the optical system (irradiating/condensing optical system) that irradiates the processing position of workpiece 2 with the analysis light is not limited to beam splitter 34 and lens 35; the optical system may be configured from optical elements other than beam splitter 34 and lens 35, and may include other optical elements in addition to beam splitter 34 and lens 35. The analysis light emitted from light source 32 may be monochromatized by a spectrometer or a filter that transmits a specific wavelength band. The analysis light that irradiates workpiece 2 includes at least one of the first wavelength (λ1), which is the peak wavelength of first laser beam L1, or the second wavelength (λ2), which is the peak wavelength of second laser beam L2. In the present embodiment, the analysis light that irradiates workpiece 2 includes both the first wavelength and the second wavelength. More specifically, workpiece 2 is irradiated by first analysis light including the first wavelength and second analysis light including the second wavelength.

In other words, light source 32 emits first analysis light and second analysis light. More specifically, light source 32 includes a first light source that emits first analysis light having a peak wavelength of the first wavelength (λ1), which is the same as the peak wavelength of first laser beam L1, and a second light source that emits second analysis light having a peak wavelength of the second wavelength (λ2), which is the same as the peak wavelength of second laser beam L2. Light source 32 includes, for example, a laser oscillator including a semiconductor laser element, or a light emitting diode (LED). In the present embodiment, light source 32 includes a first laser element that emits, as the first analysis light, a laser beam having a peak wavelength of λ1, and a second laser element that emits, as the second analysis light, a laser beam having a peak wavelength of λ2.

In this case, the first analysis light and the second analysis light emitted from light source 32 are reflected by beam splitter 34 and condensed by lens 35 before irradiating workpiece 2. The first analysis light and the second analysis light that irradiate workpiece 2 are reflected by workpiece 2 and then incident on analyzer 30 as signal light. In other words, the signal light from workpiece 2 includes first signal light, which is the first analysis light that irradiates and is reflected by workpiece 2, and second signal light, which is the second analysis light that irradiates and is reflected by workpiece 2. The first signal light is the light pertaining to the first wavelength (λ1) that is included in the first analysis light, and the second signal light is the light pertaining to the second wavelength (λ2) that is included in the second analysis light.

Here, the first analysis light of the first wavelength (λ1) and the second analysis light of the second wavelength (λ2) do not necessarily need to be condensed onto workpiece 2 by the same optical system, and may be condensed onto workpiece 2 by different optical paths using a plurality of optical systems according to the wavelength of light source 32. Moreover, the signal light from workpiece 2 does not need to be guided to the detectors using the same optical system as the first analysis light and the second analysis light; an optical system that can collect the signal light at a wide angle is more desirable to detect light that has been scattered by the surface of workpiece 2 as well. Furthermore, when the first analysis light and the second analysis light are laser beams, a polarization filter may be provided to irradiate workpiece 2 with specific polarized light and block polarized first and second analysis light from passing through the optical path of the signal light from workpiece 2 using a polarization optical system. This makes it possible to detect signal light from workpiece 2 with a high signal-to-noise ratio (S/N).

In this way, data processor 31 adjusts the processing conditions for workpiece 2 by analyzing the analysis light emitted from light source 32 and reflected by workpiece 2. More specifically, data processor 31 adjusts the processing conditions for workpiece 2 by analyzing the first analysis light emitted from light source 32 and reflected by workpiece 2 as the first signal light, and also analyzing the second analysis light emitted from light source 32 and reflected by workpiece 2 as the second signal light.

More specifically, data processor 31 adjusts the processing conditions for workpiece 2 by comparing the intensity of the first signal light with the intensity of the second signal light at the coordinates of the processing position of workpiece 2. Even more specifically, data processor 31 adjusts the processing conditions corresponding to the coordinates of the processing position of the workpiece by analyzing the reflection intensities of the first analysis light and the second analysis light based on the intensities of the first signal light and the second signal light and associating the coordinates of the processing position of the workpiece with the reflection intensities of the first analysis light and the second analysis light. Data processor 31 moreover corrects the intensities of the first signal light and the second signal light received by first detector 33a with the intensities of the first analysis light and the second analysis light received by second detector 33b, respectively.

In the present embodiment, the intensities of the first signal light and the second signal light are detected using first detector 33a and second detector 33b. As one example, first detector 33a and second detector 33b are photodetectors.

In such cases, first detector 33a receives the first signal light resulting from the first analysis light emitted from light source 32 being reflected by workpiece 2 and the second signal light resulting from the second analysis light emitted from light source 32 being reflected by workpiece 2. In the present embodiment, the first signal light and the second signal light from workpiece 2 pass through beam splitter 34 and are incident on first detector 33a.

Second detector 33b receives at least part of the first analysis light and at least part of the second analysis light. In the present embodiment, the first analysis light and the second analysis light emitted from light source 32 pass through beam splitter 34 and are incident on second detector 33b.

Data processor 31 calculates the reflectance at each of the first wavelength (λ1) and the second wavelength (λ2) based on the intensities of the first signal light and the second signal light received by first detector 33a and the intensities of the first analysis light and the second analysis light received by second detector 33b, and adjusts the processing conditions for workpiece 2. Stated differently, data processor 31 adjusts the intensity (output power) of first laser beam L1 of first laser oscillator 11 and the intensity (output power) of second laser beam L2 of second laser oscillator 12 according to the respective calculated reflectances at the first wavelength (λ1) and the second wavelength (λ2).

R(λ1) and R(λ2), which are the respective reflectances at the first wavelength (λ1) and the second wavelength (λ2), are expressed as shown in Equations 1 and 2 below. Here, I_{ref}(λ1) is the intensity (reflected light intensity) of the first signal light received by first detector 33a, I_{ref}(λ2) is the intensity (reflected light intensity) of the second signal light received by first detector 33a, Iᵢₙ(λ1) is the intensity (light source light intensity) of the first analysis light received by second detector 33b, and Iᵢₙ(λ2) is the intensity (light source light intensity) of the second analysis light received by second detector 33b.

$$\begin{matrix}[ Math . 1 ] & \\ R ( λ 1 ) = \frac{{I}_{ref} ( λ 1 )}{{I}_{i n} ( λ 1 )} & ( Equation 1 )\end{matrix}$$

$$\begin{matrix}[ Math . 2 ] & \\ R ( λ 2 ) = \frac{{I}_{ref} ( λ 2 )}{{I}_{i n} ( λ 2 )} & ( Equation 2 )\end{matrix}$$

Since Iᵢₙ at this time replaces the output power values of the first analysis light and second analysis light at light source 32, it is desirable that the output power be corrected for the loss of light due to the optical system in FIG. 5, for example. Since the same can be said for the optical system that condenses the signal light from workpiece 2, it is desirable to take NA or transmittance into consideration and make corrections for I_{ref} as well.

When data processor 31 calculates R(λ1) and R(λ2) and determines that R(λ1)>R(λ2), data processor 31 adjusts the processing conditions for workpiece 2 so that the processing position of workpiece 2 is mainly irradiated by second laser beam L2. More specifically, data processor 31 adjusts the processing conditions for workpiece 2 so as to drive first laser oscillator 11 to turn first laser oscillator 11 off or decrease the output power of first laser beam L1 emitted from first laser oscillator 11, and drive second laser oscillator 12 to turn second laser oscillator 12 on or increase the output power of second laser beam L2 emitted from second laser oscillator 12.

When data processor 31 calculates R(λ1) and R(λ2) and determines that R(λ1)<R(λ2), data processor 31 adjusts the processing conditions for workpiece 2 so that the processing position of workpiece 2 is mainly irradiated by first laser beam L1. More specifically, data processor 31 adjusts the processing conditions for workpiece 2 so as to drive first laser oscillator 11 to turn first laser oscillator 11 on or increase the output power of first laser beam L1 emitted from first laser oscillator 11, and drive second laser oscillator 12 to turn second laser oscillator 12 or decrease the output power of second laser beam L2 emitted from second laser oscillator 12.

Drive controller 20 drives each of first laser oscillator 11 and second laser oscillator 12 according to the processing conditions adjusted by data processor 31 to change the intensities of first laser beam L1 and second laser beam L2 and irradiate workpiece 2 with first laser beam L1 and second laser beam L2.

In the present embodiment, laser processing device 1A includes first optical fiber 41, second optical fiber 42, and optical system 50.

First laser beam L1 emitted from first laser oscillator 11 is transmitted through first optical fiber 41 and irradiates workpiece 2 via optical system 50. Second laser beam L2 emitted from second laser oscillator 12 is transmitted through second optical fiber 42 and irradiates workpiece 2 via optical system 50.

Optical system 50 includes half mirror 51 and lens 52. Half mirror 51 transmits first laser beam L1 and reflects second laser beam L2. Lens 52 is one example of a condensing optical element, and condenses first laser beam L1 that has transmitted through half mirror 51 and irradiates workpiece 2 with the condensed first laser beam L1, and condenses second laser beam L2 that has been reflected by half mirror 51 and irradiates workpiece 2 with the condensed second laser beam L2. Although a plurality of lenses 52 are provided in this example, a single lens 52 may be provided.

In the present embodiment, drive circuit 21 can control the position of lens 52. For example, when data processor 31 calculates that R(λ1)>R(λ2), drive circuit 21 controls the position of lens 52 so that second laser beam L2 condenses on workpiece 2, and when data processor 31 calculates that R(λ1)<R(λ2), drive circuit 21 controls the position of lens 52 so that first laser beam L1 condenses on workpiece 2. When R(λ1)=R(λ2), drive circuit 21 may select either first laser beam L1 or second laser beam L2.

Drive circuit 21 may be configured to control the position of processing table 3. In other words, drive circuit 21 may move processing table 3 in the X-axis, Y-axis, and Z-axis directions to change the position of processing table 3. This makes it possible to change the positions of first laser beam L1 and second laser beam L2, which irradiate the processing position of workpiece 2 placed on processing table 3, and change the positions of the first analysis light and the second analysis light, which irradiate the processing position of workpiece 2 placed on processing table 3. This applies to the other embodiments as well.

Although data processor 31 adjusts the processing conditions for workpiece 2 based on the magnitude relationship (difference) between reflectances R(λ1) and R(λ2) in the present embodiment, the present disclosure is not limited to this example. For example, data processor 31 may adjust the processing conditions for workpiece 2 based only on the magnitude relationship (difference) between I_{ref}(λ1) and I_{ref}(λ2), which are the respective intensities (reflected light intensities) of the first signal light and the second signal light received by first detector 33a. In such cases, if data processor 31 determines that I_{ref}(λ1)>I_{ref}(λ2), data processor 31 adjusts the processing conditions for workpiece 2 so that the processing position of workpiece 2 is mainly irradiated by second laser beam L2, and if data processor 31 determines that I_{ref}(λ1)<I_{ref}(λ2), data processor 31 adjusts the processing conditions for workpiece 2 so that the processing position of workpiece 2 is mainly irradiated by first laser beam L1. However, in such cases, it is desirable that the wavelength dependence of the light output of light source 32 be small and desirable that the intensity of the first analysis light including the first wavelength (λ1) be the same as the intensity of the second analysis light including the second wavelength (λ2).

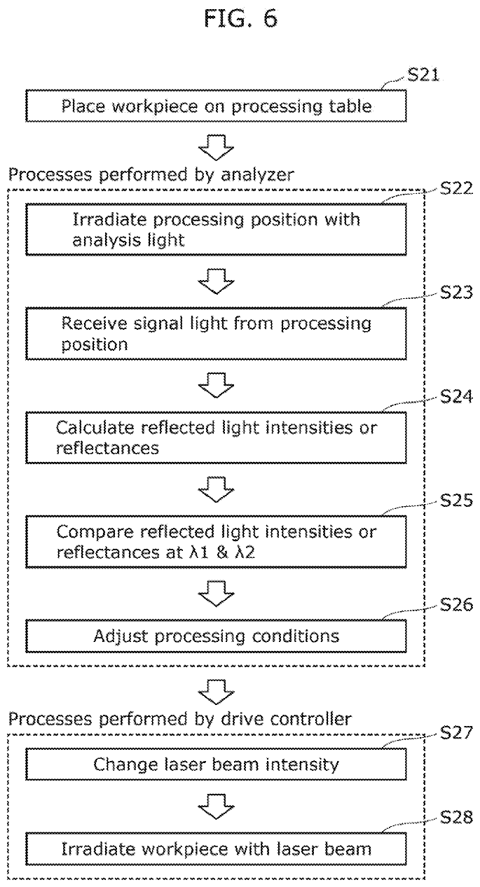

Next, the laser processing method according to the present embodiment that uses laser processing device 1A will be described with reference to FIG. 5 and FIG. 6. FIG. 6 is a flowchart of the laser processing method according to Embodiment 2.

As illustrated in FIG. 6, first, workpiece 2 is placed on processing table 3 (step S21). Step S21 is the same as step S11 in the laser processing method according to Embodiment 1 described above.

Next, the processing position of workpiece 2 is irradiated with analysis light including the first wavelength (λ1) and the second wavelength (λ2) (step S22). More specifically, the first analysis light and the second analysis light emitted from light source 32 irradiate the processing position of workpiece 2.

Next, the signal light from the processing position of workpiece 2 is received (step S23). More specifically, the first signal light and the second signal light, which are, respectively, the reflected light of the first analysis light and the second analysis light that irradiate the processing position of workpiece 2, are received by first detector 33a.

Next, the reflected light intensities or reflectances are calculated (step S24). More specifically, based on the first signal light and the second signal light received by first detector 33a, Iᵣₑf(λ1) and I_{ref}(λ2), which are the respective intensities (reflected light intensities) of the first signal light and the second signal light, are calculated. Moreover, based on the first analysis light and the second analysis light received by second detector 33b, Iᵢₙ(λ1) and Iᵢₙ(λ2), which are the respective intensities (light source light intensities) of the first analysis light and the second analysis light, are calculated, and the respective reflectances R(λ1) and R(λ2) at the first wavelength (λ1) and the second wavelength (λ2) are calculated.

Next, the reflected light intensities or the reflectances for the first wavelength (λ1) and the second wavelength (λ2) are compared (step S25). More specifically, data processor 31 compares the magnitude relationship between reflected light intensity I_{ref}(λ1) for the first wavelength (λ1) with reflected light intensity I_{ref}(λ2) for the second wavelength (λ2), or the magnitude relationship between reflectance R(λ1) for the first wavelength (λ1) with reflectance R(λ2) for the second wavelength (λ2).

Next, the processing conditions for workpiece 2 are adjusted based on the comparison result of step S25 (step S26). More specifically, the processing conditions for workpiece 2 are adjusted according to the magnitude relationship between I_{ref}(λ1) and I_{ref}(λ2) from step S25 or the processing conditions for workpiece 2 are adjusted according to the magnitude relationship between R(λ1) and R(λ2) from step S25.

Next, laser beam intensity is changed based on the adjusted processing conditions (step S27). More specifically, the intensity of first laser beam L1 emitted from first laser oscillator 11 and the intensity of second laser beam L2 emitted from second laser oscillator 12 are changed according to the processing conditions adjusted in step S26.

Next, workpiece 2 is irradiated by laser beam (step S28).

More specifically, first laser beam L1 is emitted from first laser oscillator 11 and irradiates the processing position of workpiece 2 at the intensity set in step S27 and/or second laser beam L2 is emitted from second laser oscillator 12 and irradiates the processing position of workpiece 2 at the intensity set in step S27. Step S16 is performed by drive controller 20.

The laser processing method according to the present embodiment can be performed by following the above steps. In such cases, the laser processing may be completed by performing the sequence of steps S22 to S28 only once as described above, or by repeatedly performing the sequence of steps S22 to S28 a plurality of times in real time.

Just like in Embodiment 1 described above, with laser processing device 1A according to the present embodiment, analyzer 30 obtains the signal light from workpiece 2 and adjusts the processing conditions for workpiece 2 based on the obtained signal light, and drive controller 20 drives first laser oscillator 11 and second laser oscillator 12 according to the adjusted processing conditions to change the intensity of at least one of first laser beam L1 or second laser beam L2 and irradiate workpiece 2 with at least one of first laser beam L1 or second laser beam L2.

In this way, with laser processing device 1A according to the present embodiment as well, signal light obtained from workpiece 2 is analyzed to obtain material information about workpiece 2, the processing conditions are adjusted according to the obtained material information, and first laser oscillator 11 and second laser oscillator 12 are driven according to the adjusted processing conditions.

Since this allows first laser beam L1 and second laser beam L2 to irradiate the processing position of workpiece 2 based on processing conditions suitable for the material of workpiece 2, high quality laser processing with high throughput can be achieved.

In laser processing device 1A according to the present embodiment, analyzer 30 includes data processor 31 that analyzes signal light from workpiece 2.

By analyzing the signal light from workpiece 2, material information about workpiece 2 can be obtained with high accuracy, thus improving the accuracy of wavelength selection when laser processing workpiece 2. This achieves high quality laser processing.

In laser processing device 1A according to the present embodiment, analyzer 30 adjusts the processing conditions corresponding to the coordinates of the processing position of workpiece 2 obtained when the signal light from workpiece 2 is obtained, and drive controller 20 drives first laser oscillator 11 and second laser oscillator 12 according to the adjusted processing conditions to irradiate workpiece 2 with at least one of first laser beam L1 or second laser beam L2 based on the coordinates of the processing position of workpiece 2.

Material information corresponding to the coordinates of the processing position of workpiece 2 can thus be obtained by analyzing the signal light obtained from the coordinates. This makes it possible to adjust the processing conditions according to the material information and drive either first laser oscillator 11 or second laser oscillator 12, whichever is suitable for the laser processing, thus achieving high quality laser processing.

In laser processing device 1A according to the present embodiment, data processor 31 adjusts the processing conditions corresponding to the coordinates of the processing position of workpiece 2 based on the signal light from workpiece 2.

With this configuration, material information about workpiece 2 can be obtained with high accuracy, thus further improving the accuracy of wavelength selection when laser processing workpiece 2. This achieves even higher quality laser processing.

In laser processing device 1A according to the present embodiment, analyzer 30 includes light source 32 that emits analysis light that irradiates workpiece 2 and an optical system that irradiates the processing position of workpiece 2 with the analysis light, and the signal light from workpiece 2 is at least part of the analysis light from light source 32 reflected by a surface of workpiece 2.

By treating the reflected light of workpiece 2 as the signal light from workpiece 2, the reflected light of the analysis light of workpiece 2, which is dependent on the physical properties of the material, such as light absorption and transmission, can be obtained as the signal light. This improves the adjustment accuracy of the laser processing conditions, which depend on the material of workpiece 2, thus realizing a laser processing device that can perform higher quality laser processing.

In laser processing device 1A according to the present embodiment, the analysis light that irradiates workpiece 2 includes first analysis light having a peak wavelength of the first wavelength, which is the same as the peak wavelength of first laser beam L1, and second analysis light having a peak wavelength of the second wavelength, which is the same as the peak wavelength of second laser beam L2, and the signal light from workpiece 2 includes first signal light, which is the first analysis light that irradiates and is reflected by workpiece 2, and second signal light, which is the second analysis light that irradiates and is reflected by workpiece 2. Data processor 31 then adjusts the processing conditions by comparing the intensities of the first signal light and the second signal light at the coordinates of the processing position of the workpiece, or comparing the reflectances at the first wavelength and the second wavelength at the coordinates of the processing position of workpiece 2.

By comparing the reflection intensities or the reflectances at the two wavelengths, it is possible to determine which of first laser beam L1 and second laser beam L2 is suitable for the material at the processing position. It is thus possible to realize a laser processing device that can perform even higher quality laser processing.

In laser processing device 1A according to the present embodiment, the analysis light that irradiates workpiece 2 includes at least one of the first wavelength, which is the peak wavelength of first laser beam L1, or the second wavelength, which is the peak wavelength of second laser beam L2.

With this configuration, since the analysis light includes the oscillation wavelength of the laser beam to be used for processing, the reflection intensity or reflectance at the wavelength of the laser beam to be used for processing can be analyzed for the coordinates of the processing position of the workpiece. This improves the adjustment accuracy of the processing conditions, which makes it possible to realize a laser processing device that can perform even higher quality laser processing.

In laser processing device 1A according to the present embodiment, data processor 31 adjusts the processing conditions corresponding to the coordinates of the processing position of workpiece 2 by analyzing the reflectance of the analysis light irradiating workpiece 2 based on the intensity of the signal light from workpiece 2 and associating the coordinates of the processing position of workpiece 2 with the reflectance.

This makes it possible to analyze the reflection intensity or reflectance, which is dependent on the chemical composition or surface condition of the material at the processing position of workpiece 2, and improve the analysis accuracy of material properties. This therefore improves the adjustment accuracy of the laser processing conditions, which depend on the material at the processing position of workpiece 2, thus realizing a laser processing device that can perform higher quality laser processing.

Moreover, in laser processing device 1A according to the present embodiment, analyzer 30 includes first detector 33a and second detector 33b, first detector 33a receives signal light, the signal light being the analysis light that irradiates and is reflected by workpiece 2, and second detector 33b receives at least part of the analysis light that irradiates workpiece 2. Data processor 31 corrects the intensity of the signal light received by first detector 33a with the intensity of the analysis light received by second detector 33b.

This makes it possible to simultaneously detect the intensity of the analysis light irradiating workpiece 2 and the signal light from workpiece 2, and thus obtain the reflection intensity or reflectance that compensates for variations in or wavelength dependence of light source 32 that emits the analysis light. This consequently improves the analysis accuracy of the material properties at the processing position of workpiece 2, which in turn improves the adjustment accuracy of the laser processing conditions, which depend on the material at the processing position of workpiece 2. It is thus possible to realize a laser processing device that can perform even higher quality laser processing.

In laser processing device 1A according to the present embodiment, light source 32 that emits the analysis light includes a laser oscillator or an LED.

Since monochromatized analysis light irradiates workpiece 2 with this configuration, the reflection intensity or reflectance at a specific wavelength can be obtained. This consequently further improves the analysis accuracy of the material properties at the processing position of workpiece 2, which in turn further improves the adjustment accuracy of the laser processing conditions, which depend on the material at the processing position of workpiece 2. It is thus possible to realize a laser processing device that can perform even further higher quality laser processing.

In laser processing device 1A according to the present embodiment, the analysis light that irradiates workpiece 2 may be monochromatized by a spectrometer or a filter that transmits a specific wavelength band.

In such cases as well, since monochromatized analysis light irradiates workpiece 2 with this configuration, the reflection intensity or reflectance at a specific wavelength can be obtained. This further improves the analysis accuracy of material properties at the processing position of workpiece 2 and the adjustment accuracy of the laser processing conditions, which depend on the material at the processing position of workpiece 2, thereby achieving high quality laser processing.

Although light source 32 is exemplified as being included in analyzer 30 in the present embodiment, light source 32 is not limited to this example and need not be included in analyzer 30.

### Embodiment 3

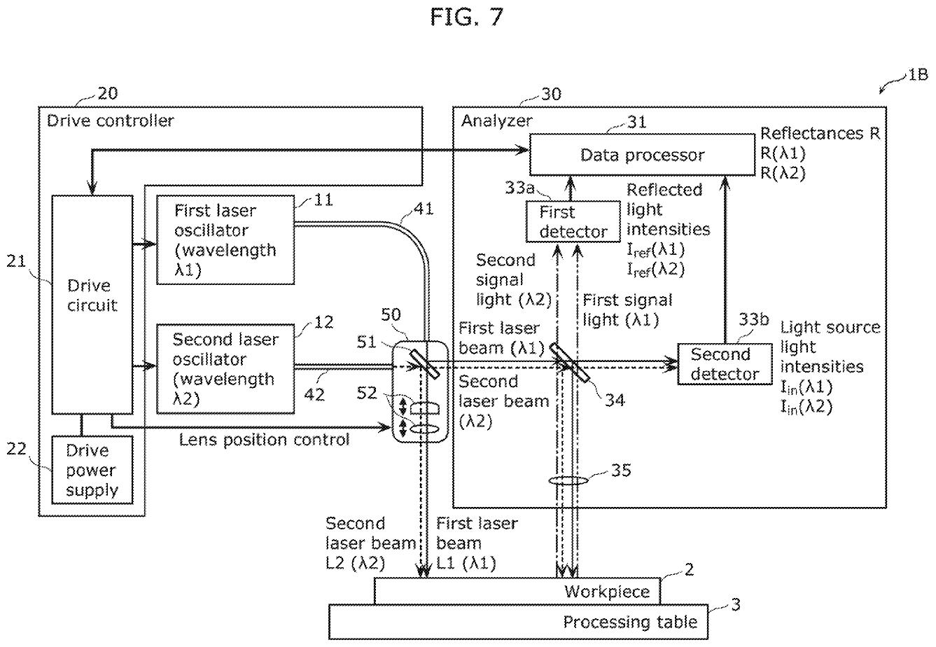

First, the configuration of laser processing device 1B according to Embodiment 3 will be described with reference to FIG. 7. FIG. 7 is a block diagram illustrating the configuration of laser processing device 1B according to Embodiment 3.

Just like laser processing device 1A according to Embodiment 2 described above, in laser processing device 1B according to the present embodiment as well, the analysis light that irradiates workpiece 2 includes at least one of the first wavelength (λ1) or the second wavelength (λ2), but laser processing device 1B according to the present embodiment differs from laser processing device 1A according to Embodiment 2 described above in that light source 32 that emits the analysis light that irradiates workpiece 2 is not provided as a separate element, but rather the laser beam to be used for processing is also used as the analysis light instead.

In other words, in laser processing device 1B according to the present embodiment, the analysis light that irradiates workpiece 2 is produced by guiding part of at least one of first laser beam L1 emitted from first laser oscillator 11 or second laser beam L2 emitted from second laser oscillator 12.

More specifically, as illustrated in FIG. 7, in laser processing device 1B according to the present embodiment, first laser beam L1 emitted from first laser oscillator 11 irradiates workpiece 2 as first analysis light and second laser beam L2 emitted from second laser oscillator 12 irradiates workpiece 2 as second analysis light.

Accordingly, in the present embodiment, half mirror 51 reflects part of first laser beam L1 emitted from first laser oscillator 11 so as to be incident on beam splitter 34 of analyzer 30, and transmits part of second laser beam L2 emitted from second laser oscillator 12 so as to be incident on beam splitter 34 of analyzer 30. First laser beam L1 and second laser beam L2 incident on beam splitter 34 then irradiate the processing position of workpiece 2 as the first analysis light and the second analysis light.

First laser beam L1 that is emitted from first laser oscillator 11 and irradiates workpiece 2 as the first analysis light and second laser beam L2 that is emitted from second laser oscillator 12 and irradiates workpiece 2 as the second analysis light are reflected by workpiece 2 and incident on first detector 33a.

Moreover, part of first laser beam L1 and part of second laser beam L2 incident on beam splitter 34 are transmitted by beam splitter 34 and incident on second detector 33b. Since this configuration allows first laser beam L1 serving as the first analysis light and second laser beam L2 serving as the second analysis light to be received by second detector 33b, the intensity of first laser beam L1 serving as the first analysis light and the intensity of second laser beam L2 serving as the second analysis light can be detected.

In the present embodiment, the laser processing system is essentially same as laser processing device 1A according to Embodiment 2 described above, except that the laser beam for processing is also used as the analysis light that irradiates workpiece 2. For example, the processes performed by data processor 31 are the same as in Embodiment 2 described above.

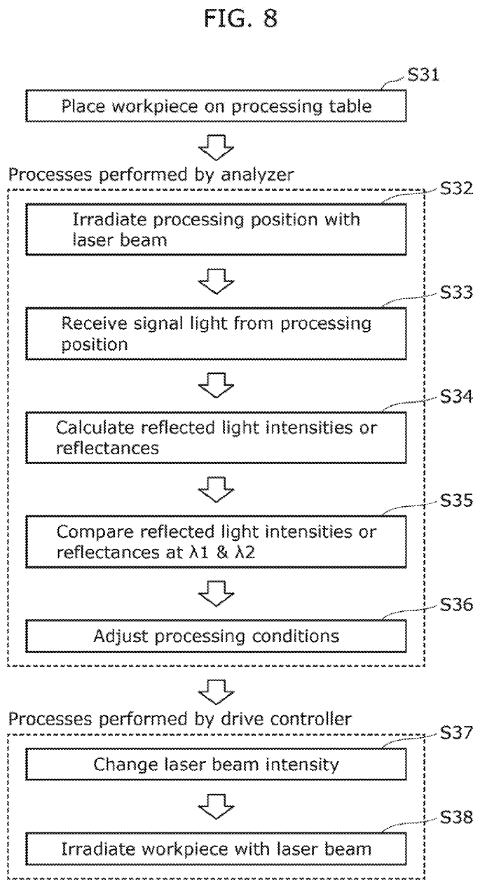

Next, the laser processing method according to the present embodiment that uses laser processing device 1B will be described with reference to FIG. 8. FIG. 8 is a flowchart of the laser processing method according to Embodiment 3.

As illustrated in FIG. 8, the laser processing method according to the present embodiment includes steps S31 to S38.

The laser processing method according to the present embodiment differs from the laser processing method according to Embodiment 2 described above in regard to step S32 only. Steps S31 and S33 to S38 are the same as steps S21 and S23 to S28, respectively, in the laser processing method according to Embodiment 2 described above and illustrated in FIG. 6.

In the laser processing method according to Embodiment 2 described above, in step S22, the first analysis light and the second analysis light are emitted from light source 32 and irradiate the processing position of workpiece 2, but in the laser processing method according to the present embodiment, in step S32, first laser beam L1 and second laser beam L2 are respectively emitted from first laser oscillator 11 and second laser oscillator 12 and irradiate the processing position of workpiece 2.

Laser processing device 1B according to the present embodiment thus achieves the same advantageous effects as laser processing device 1A according to Embodiment 2 described above. For example, laser processing device 1B according to the present embodiment achieves the advantageous effect of high quality laser processing with high throughput.

Laser processing device 1B according to the present embodiment also differs from Embodiment 2 described above in that the analysis light that irradiates workpiece 2 is produced by guiding part of at least one of first laser beam L1 and second laser beam L2, which are laser beams used for processing.

Since the laser beam emitted from a laser oscillator is directly used as analysis light with this configuration, the reflectance or reflection intensity of workpiece 2 at the wavelength of the laser beam emitted from the laser oscillator can be analyzed. It is thus possible to realize a laser processing device that can perform even higher quality laser processing since the adjustment accuracy of the laser processing conditions is further improved.

Moreover, by using the laser beam from a laser oscillator as the analysis light, a light source specifically for analysis light (light source 32) is not required as in Embodiment 2 above. This makes it possible to achieve a small laser processing device.

Note that in the present embodiment, first laser beam L1 and second laser beam L2 respectively used as the first analysis light and the second analysis light may have the same intensities as first laser beam L1 and second laser beam L2 that are used as laser beams for processing workpiece 2, and may have lower intensities than first laser beam L1 and second laser beam L2 that are used as laser beams for processing workpiece 2. If the processing position of workpiece 2 is to be irradiated with both the analysis light and a laser beam for processing at the same time, a laser beam emitted from one of the laser oscillators may be divided into the analysis light and the laser beam for processing. For example, first laser beam L1 emitted from first laser oscillator 11 may be divided such that 1% is used for the first analysis light and 99% is used as the laser beam for processing. Although it is not necessary to irradiate the processing position of workpiece 2 with both the analysis light and the laser beam for processing at the same time, in such cases, the analysis light may irradiate a position slightly in front of the position irradiated by the laser beam for processing.

Although the same light source is used for the analysis light (the first analysis light and the second analysis light) and the laser beam for processing, the timing of the analysis light irradiation and the laser beam irradiation for processing may be different. In such cases, the direction in which light from the laser oscillator is guided may be switched by driving optical system 50 and half mirror 51 so that when irradiating with the analysis light, a mirror is arranged to guide the light to analyzer 30, and when irradiating workpiece 2 with the laser beam, the laser beam is guided to the processing position.

### Embodiment 4

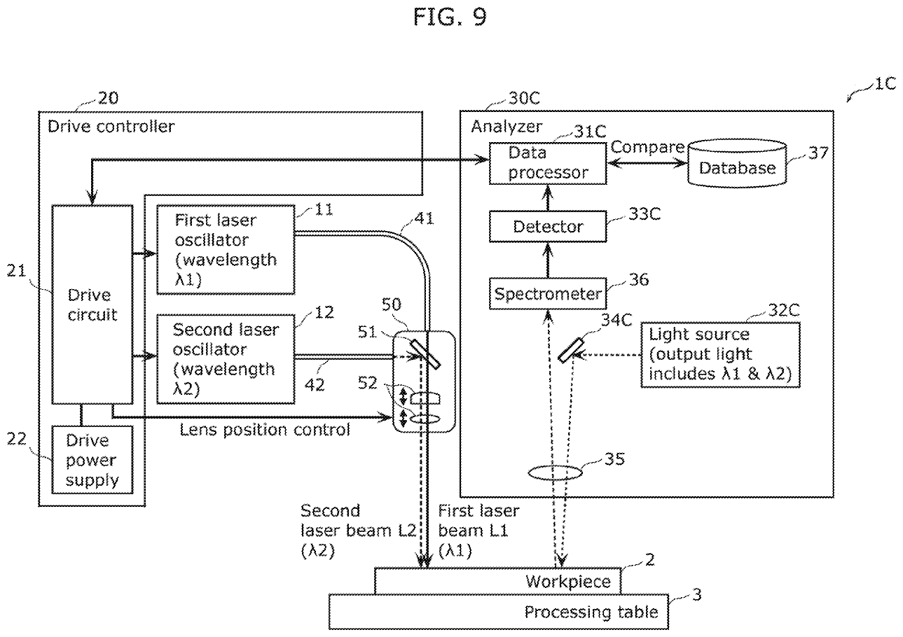

First, the configuration of laser processing device 1C according to Embodiment 4 will be described with reference to FIG. 9. FIG. 9 is a block diagram illustrating the configuration of laser processing device 1C according to Embodiment 4.

As illustrated in FIG. 9, just like laser processing device 1A according to Embodiment 2 described above, laser processing device 1C according to the present embodiment includes first laser oscillator 11, second laser oscillator 12, drive controller 20, and analyzer 30C.

In laser processing device 1A according to Embodiment 2 described above, reflectance R(λ1) at the first wavelength is compared with reflectance R(λ2) at the second wavelength and/or reflection intensity I_{ref}(λ1) at the first wavelength is compared with reflection intensity I_{ref}(λ2) at the second wavelength to select the laser beam to be used in the laser processing, but in laser processing device 1C according to the present embodiment, the material of workpiece 2 is identified from the reflection intensity spectrum of workpiece 2 to select the laser beam to be used in the laser processing.

More specifically, laser processing device 1C according to the present embodiment differs from laser processing device 1A according to Embodiment 2 described above in regard to the configuration of analyzer 30C. More specifically, analyzer 30C according to the present embodiment includes data processor 31C, light source 32C, detector 33C, mirror 34C, lens 35, spectrometer 36, and database 37.

Light source 32C emits, as analysis light that irradiates workpiece 2, light that includes the first wavelength (λ1), which is the peak wavelength of first laser beam L1 emitted by first laser oscillator 11, and the second wavelength (λ2), which is the peak wavelength of second laser beam L2 emitted by second laser oscillator 12. In the present embodiment, light source 32 emits white light including λ1 and λ2, and A1>λ2.

Spectrometer 36 separates the signal light from workpiece 2. More specifically, spectrometer 36 separates the signal light, which is the analysis light that is emitted from light source 32, reflected by mirror 34C, condensed by lens 35, and then irradiates workpiece 2.

The signal light separated by spectrometer 36 is incident on detector 33C. Detector 33C measures the signal light from workpiece 2 that has been separated by spectrometer 36 to measure the reflection spectrum, which indicates the wavelength dependence of the intensity or the reflectance of the signal light from workpiece 2.

Database 37 stores a data set of reflection spectrums for respective materials. More specifically, database 37 stores a data set including at least reflection spectrums for possible materials of workpiece 2. Database 37 stores a plurality of items of data of known material reflection spectrums.

Data processor 31C adjusts the processing conditions corresponding to the coordinates of the processing position of workpiece 2 based on the reflection spectrum measured by detector 33C. More specifically, data processor 31C is connected to database 37, and compares the reflection spectrum obtained from the signal light from workpiece 2 with the data set of the reflection spectrums stored in database 37, determines which of the materials stored in database 37 the material at the coordinates of the processing position of workpiece 2 is closest to, and adjusts the processing conditions corresponding to the coordinates of the processing position of workpiece 2 according to the determined material.

In such cases, if there is a reflection spectrum in the data set in database 37 that matches the reflection spectrum obtained from the signal light from workpiece 2, the material corresponding to that reflection spectrum can be identified as the material of workpiece 2, but even when there is no reflection spectrum in the data set in database 37 that matches the reflection spectrum obtained from the signal light from workpiece 2, the material of workpiece 2 can be determined using the closest reflection spectrum in the data set in database 37.

Note that data for newly obtained reflection spectrums and workpiece materials may be linked and added to database 37. This makes it possible to expand and enhance database 37. Moreover, the reflection spectrum comparison results and the processing conditions may be linked and stored once again in database 37.

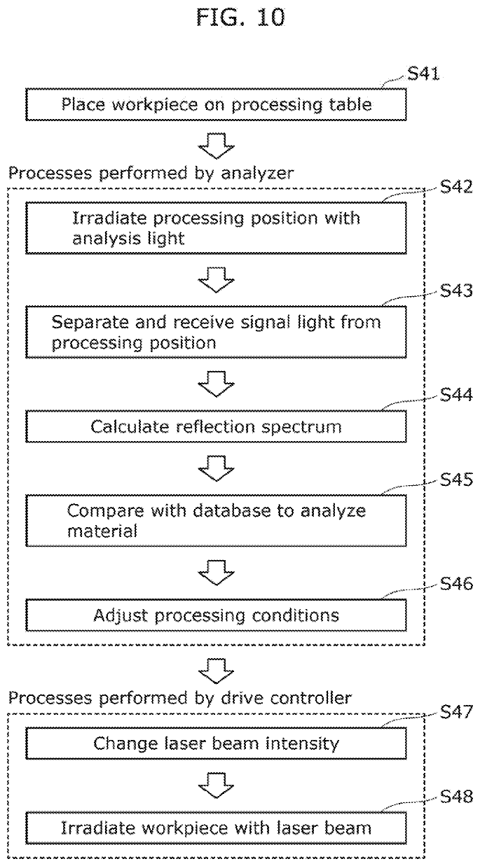

Next, the laser processing method according to the present embodiment that uses laser processing device 1C will be described with reference to FIG. 10. FIG. 10 is a flowchart of the laser processing method according to Embodiment 4.

As illustrated in FIG. 10, first, workpiece 2 is placed on processing table 3 (step S41). Step S41 is the same as step S21 in the laser processing method according to Embodiment 2 described above.

Next, the processing position of workpiece 2 is irradiated with analysis light including the first wavelength (λ1) and the second wavelength (λ2) (step S42). More specifically, analysis light including the first wavelength and the second wavelength emitted from light source 32C irradiate the processing position of workpiece 2.

Next, the signal light from the processing position of workpiece 2 is separated and received (step S43). More specifically, the signal light, which is the light of each of the analysis lights that irradiates and is and reflected by the processing position of workpiece 2, is separated by spectrometer 36, and the signal light separated by spectrometer 36 is received by detector 33C.

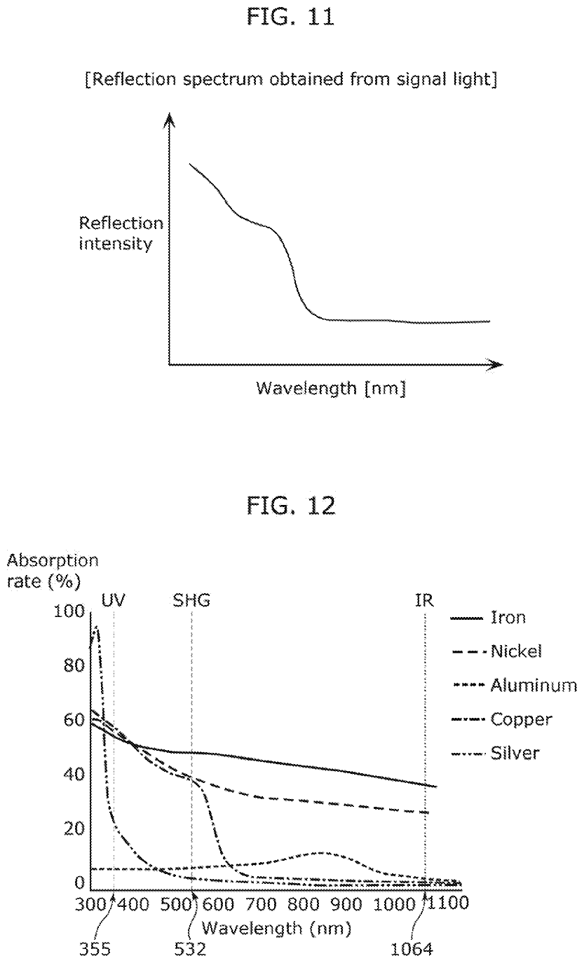

Next, the reflection spectrum, which indicates the wavelength dependence of the intensity or the reflectance of the signal light from workpiece 2, is calculated (step S44). More specifically, the reflection spectrum, which indicates the wavelength dependence of reflection intensity, as is illustrated in FIG. 11, is calculated by measuring the signal light separated by spectrometer 36 and received by detector 33C.

Next, the measured reflection spectrum of the signal light is compared with database 37 to analyze the material (step S45). More specifically, the reflection spectrum measured by detector 33C is compared with the data set of reflection spectrums for respective materials—like illustrated in FIG. 12—that is stored in database 37 to determine which material stored in database 37 the material at the coordinates of the processing position of workpiece 2 is closest to. For example, assume the reflection spectrum measured by detector 33C is the reflection spectrum illustrated in FIG. 11. Since the reflection spectrum illustrated in FIG. 11 is closest to the reflection spectrum for copper among the reflection spectrums illustrated in FIG. 12 (i.e., since the reflection spectrum in FIG. 11 closely matches the reflection spectrum for copper in FIG. 12), the material at the coordinates of the processing position of workpiece 2 can be determined to be copper. Stated differently, it is analyzed that the material at the processing position of workpiece 2 is most likely copper by comparing the measured reflection spectrum of the signal light with the database.

Next, the processing conditions corresponding to the coordinates of the processing position of workpiece 2 are adjusted according to the material determined in step S45 (step S46). For example, if the material of the processing position of workpiece 2 is determined to be copper, as described above, the processing conditions for laser processing are created using a laser beam having a wavelength suitable for copper (which is, in the present embodiment, second laser beam L2, which is a blue laser beam).

Next, laser beam intensity is changed based on the adjusted processing conditions (step S47). More specifically, the intensity of first laser beam L1 emitted from first laser oscillator 11 and the intensity of second laser beam L2 emitted from second laser oscillator 12 are changed according to the processing conditions adjusted in step S46.

Next, workpiece 2 is irradiated by laser beam (step S48). More specifically, first laser beam L1 is emitted from first laser oscillator 11 and irradiates the processing position of workpiece 2 at the intensity set in step S47 and/or second laser beam L2 is emitted from second laser oscillator 12 and irradiates the processing position of workpiece 2 at the intensity set in step S47.

The laser processing method according to the present embodiment can be performed by following the above steps. In such cases, just like in Embodiment 2 described above, the laser processing may be completed by performing the sequence of steps S42 to S48 only once as described above, or by repeatedly performing the sequence of steps S42 to S48 a plurality of times in real time.

With laser processing device 1C according to the present embodiment, just like in Embodiment 2 described above, analyzer 30C obtains the signal light from workpiece 2 and adjusts the processing conditions for workpiece 2 based on the obtained signal light, and drive controller 20 drives first laser oscillator 11 and second laser oscillator 12 according to the adjusted processing conditions to change the intensity of at least one of first laser beam L1 or second laser beam L2 and irradiate workpiece 2 with at least one of first laser beam L1 or second laser beam L2.

This achieves the same advantageous effects as in Embodiment 2 described above. Since this allows first laser beam L1 and second laser beam L2 to irradiate the processing position of workpiece 2 based on processing conditions suitable for the material of workpiece 2, high quality laser processing with high throughput can be achieved.

In laser processing device 1C according to the present embodiment, analyzer 30C includes spectrometer 36 that separates the signal light from workpiece 2 and detector 33C that measures the signal light separated by spectrometer 36 to measure a reflection spectrum indicating a wavelength dependence of the intensity or the reflectance of the signal light, and data processor 31C adjusts the processing conditions corresponding to the coordinates of the processing position of workpiece 2 based on the reflection spectrum measured by detector 33C.

Obtaining a reflection spectrum indicating a wavelength dependence of the reflection intensity or the reflectance of the material, which is specific to that material, improves the analysis accuracy of the material properties or chemical composition of the material at the coordinates of the processing position of workpiece 2, and improves the adjustment accuracy of the laser processing conditions, which depend on the material. It is thus possible to realize a laser processing device that can perform even higher quality laser processing.

In laser processing device 1C according to the present embodiment, data processor 31C is connected to database 37 storing a data set of reflection spectrums for respective materials, and data processor 31 compares the reflection spectrum obtained from the signal light from workpiece 2 with the data set of the reflection spectrums stored in database 37, determines which of the materials stored in database 37 the material at the coordinates of the processing position of workpiece 2 is closest to, and adjusts the processing conditions corresponding to the coordinates of the processing position of workpiece 2 according to the determined material.

Comparing the reflectance spectrum specific to the material with database 37 improves the analysis accuracy of the material properties or chemical composition of the material at the coordinates of the processing position of workpiece 2, and further improves the adjustment accuracy of the laser processing conditions, which depend on the material. It is thus possible to realize a laser processing device that can perform even further higher quality laser processing.

In the present embodiment, the signal light, which is the reflected light of the analysis light that irradiated workpiece 2, is separated by spectrometer 36 to calculate the reflection spectrum of the material of workpiece 2, but the present disclosure is not limited to this example. For example, the light separated by the spectrometer may irradiate workpiece 2 as analysis light. In such cases, analyzer 30C may include a spectrometer that separates the analysis light emitted from light source 32 and a detector that measures the signal light, which is the separated analysis light that has irradiated the processing position of workpiece 2 and been reflected by the surface of workpiece 2, to measure the reflection spectrum indicating a wavelength dependence of the intensity or the reflectance of the signal light from workpiece 2. This also achieves the same advantageous effects as in the present embodiment.

In the present embodiment, database 37 is a storage device such as memory, and analyzer 30C includes database 37, but the present disclosure is not limited to this example. Database 37 may be provided external to laser processing device 1C. Database 37 may be provided in, for example, a cloud server connected to data processor 31C over a network such as the internet. Providing database 37 in a cloud server makes it possible to implement machine learning using population intelligence to improve the accuracy of the comparison as database 37 is expanded and enhanced.

### Embodiment 5

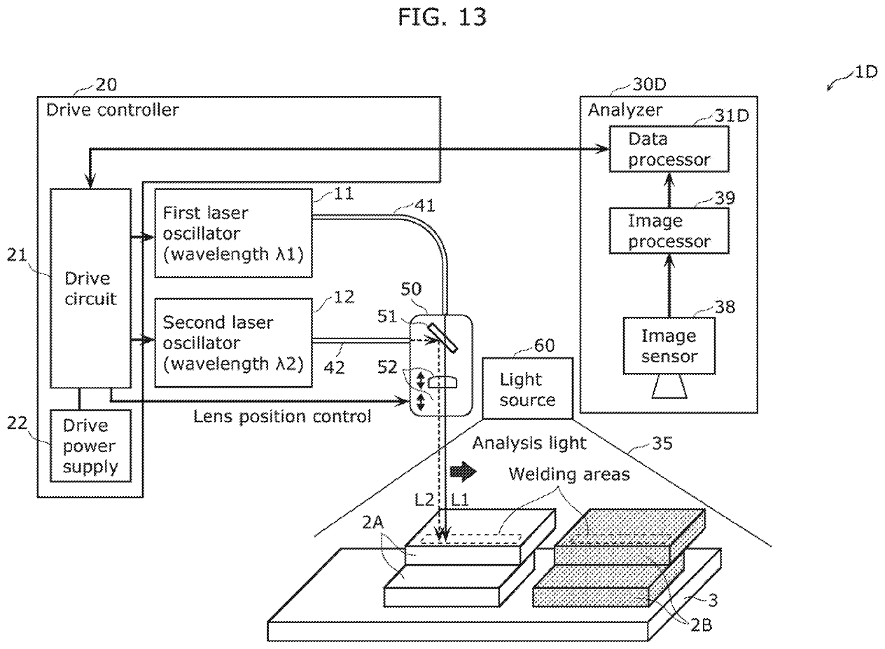

First, the configuration of laser processing device 1D according to Embodiment 5 will be described with reference to FIG. 13. FIG. 13 is a block diagram illustrating the configuration of laser processing device 1D according to Embodiment 5.

As illustrated in FIG. 13, just like laser processing devices 1A through 1C according to Embodiments 2 through 4 described above, laser processing device 1D according to the present embodiment includes first laser oscillator 11, second laser oscillator 12, drive controller 20, and analyzer 30D.

In laser processing devices 1A through 1C according to Embodiments 2 through 4 described above, the laser beam to be used in the laser processing is selected by the detector receiving and analyzing the signal light from workpiece 2, but in laser processing device 1D according to the present embodiment, the laser beam to be used in the laser processing is selected by capturing the signal light from workpiece 2 using image sensor 38.

More specifically, laser processing device 1D according to the present embodiment differs from laser processing devices 1A through 1C according to Embodiments 2 through 4 described above in regard to the configuration of analyzer 30D. More specifically, analyzer 30D according to the present embodiment includes data processor 31D, image sensor 38, and image processor 39.

Laser processing device 1D according to the present embodiment further includes light source 60. Light source 60 irradiates workpieces 2A and 2B with analysis light. The analysis light from light source 60 is, for example, white light. Note that the present embodiment differs from Embodiments 1 through 4 described above in that two workpieces 2A made of only one type of metal material are welded together and two workpieces 2B made of only one type of metal material are welded together, as illustrated in FIG. 13. For example, workpieces 2A are aluminum and workpieces 2B are copper.

Image sensor 38 is one example of the solid-state imaging element including a two-dimensional array of pixels that receive light. Image sensor 38 is a color image sensor in the present embodiment. In the present embodiment, image sensor 38 includes at least a first pixel provided with a filter that transmits near-infrared light as an example of a first filter that transmits the first wavelength (λ1), and a second filter provided with a filter that transmits wavelengths of at least part of the visible light range as an example of a second filter that transmits the second wavelength (λ2).

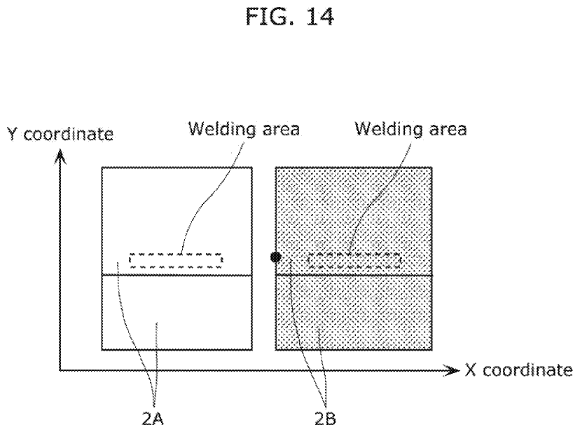

Image sensor 38 captures a two-dimensional image of workpieces 2A and 2B by receiving the signal light from workpieces 2A and 2B, and outputs the two-dimensional image to data processor 31D. More specifically, image sensor 38 captures the signal light, which is the analysis light from light source 60 that has irradiated and been reflected by workpieces 2A and 2B. The two-dimensional image captured by image sensor 38 is input into data processor 31D via image processor 39. Image processor 39 generates image data of the two-dimensional image like illustrated in FIG. 14 based on the signal light received by image sensor 38, and outputs the image data to data processor 31D.

Data processor 31D then adjusts the processing conditions for workpieces 2A and 2B according to the brightnesses corresponding to the processing positions (welding areas) of workpieces 2A and 2B in the two-dimensional image. More specifically, data processor 31D adjusts the processing conditions for workpieces 2A and 2B by comparing the pixel signal intensities at the first wavelength and the second wavelength of the signal light at each processing position of workpieces 2A and 2B in the two-dimensional image received by image sensor 38. Stated differently, in the present embodiment, the reflectances of workpieces 2A and 2B are estimated using a two-dimensional image generated using spectral pixels above which spectral filters that transmit light of a specific wavelength are provided, and for each of the coordinates, a wavelength of the laser beam to be used for processing that is suitable for the coordinates is selected based on the relationship between the coordinates of and the brightness at the processing position of workpiece 2.

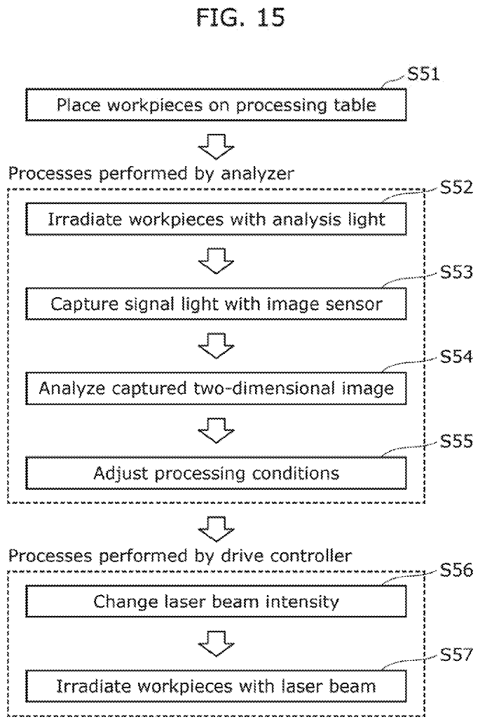

Next, the laser processing method according to the present embodiment that uses laser processing device 1D will be described with reference to FIG. 15. FIG. 15 is a flowchart of the laser processing method according to Embodiment 5.

As illustrated in FIG. 15, first, workpieces 2A and 2B are placed on processing table 3 (step S51). Step S51 is the same as step S21 in the laser processing method according to Embodiment 2 described above.

Next, analysis light irradiates the processing positions of workpieces 2A and 2B (step S52). More specifically, the analysis light emitted by light source 60 irradiates a region or regions including the processing positions of workpieces 2A and 2B.

Next, the signal light from the processing positions of workpieces 2A and 2B is captured by image sensor 38 (step S53). More specifically, the signal light, which is the analysis light from light source 60 that has irradiated the processing positions of workpieces 2A and 2B and been reflected by workpieces 2A and 2B, is captured by image sensor 38 to obtain a two-dimensional image. Stated differently, a two-dimensional image of workpieces 2A and 2B including a plurality of spectral pixels is obtained.

Next, the captured two-dimensional image is analyzed (step S54). More specifically, in the two-dimensional image captured by image sensor 38, the pixel signal intensities (spectral pixel intensities) at the first wavelength and the second wavelength of the signal light at each processing position of workpieces 2A and 2B are compared.

Next, the processing conditions corresponding to the coordinates of each processing position of workpieces 2A and 2B are adjusted according to the comparison results in step S54 (step S55).

For example, steps S54 and S55 can be performed as follows.

Since image sensor 38 includes a periodic array of spectral pixels, the signal light from workpieces 2A and 2B is received by image sensor 38 and the color and brightness (luminance) of each pixel is determined based on the intensity information from adjacent spectral pixels, whereby a two-dimensional image is captured. This allows the spectral pixel intensities to be obtained at the pixels corresponding to each of the coordinates of the processing positions of workpieces 2A and 2B.

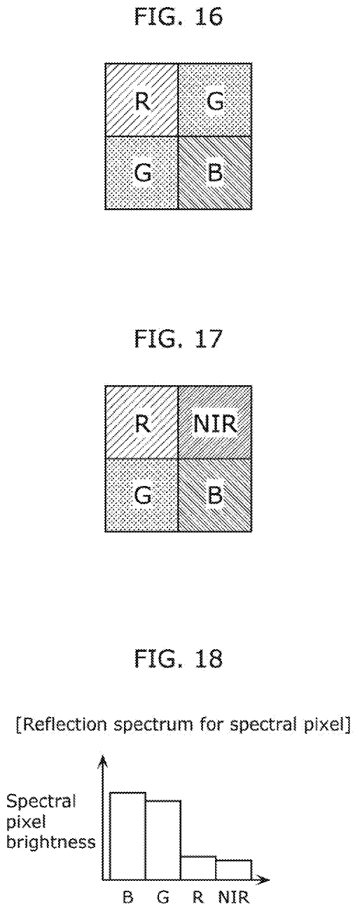

For example, the Bayer array pixel illustrated in FIG. 16 is one known example of spectral pixels of a common color image sensor. In this example, one spectral pixel includes four sub-pixels: two green sub-pixels (G), one red sub-pixel (R), and one blue sub-pixel (B). A color filter, such as pigment filter, is provided on each sub-pixel, giving each sub-pixel a specific spectral sensitivity. Normally, the brightness and color of one spectral pixel are determined by the four sub-pixels of the Bayer array pixel, and are output as a single item of data. The spectral pixels in the Bayer array include blue sub-pixels that are sensitive to blue light and red sub-pixels that are sensitive to red light, and an image can be constructed for each color scheme to obtain the reflection intensity corresponding to each of the coordinates.

In each spectral pixel of the two-dimensional image captured by image sensor 38, if the signal intensity of the blue sub-pixel is high compared to the signal intensity of the red sub-pixel, this means the reflectance of the blue light is high. Therefore, in this case, for example, one processing condition is that the laser processing is to be performed with first laser beam L1 (infrared laser processing).

However, in each spectral pixel of the two-dimensional image captured by image sensor 38, if the signal intensity of the blue sub-pixel is low compared to the signal intensity of the red sub-pixel, this means the reflectance of the blue light is low. Therefore, in this case, for example, one processing condition is that the laser processing is to be performed with second laser beam L2 (blue laser processing).

Since the green sub-pixel indicates luminance information, it is also possible to construct a monochrome two-dimensional image using the signal intensities of the green sub-pixels and display which positions on the two-dimensional image are suitable for laser processing via first laser beam L1 and which positions are suitable for laser processing via second laser beam L2. It is also possible to reproduce color by combining the outputs of the red sub-pixels with the outputs of the blue sub-pixels and display a normal color image.

The layout of each spectral pixel of image sensor 38 is not limited to the Bayer array illustrated in FIG. 16. For example, one or two of the green sub-pixels may be white pixels provided with no color filter. With this configuration, monochrome luminance images can be captured with satisfactory sensitivity for all materials because they are white pixels. As illustrated in FIG. 17, each spectral pixel of image sensor 38 may be a Bayer array pixel, and each spectral pixel may include at least one or more near-infrared (NIR) sub-pixels. With this configuration as well, an image can be constructed for each color scheme, and the reflection intensity corresponding to each of the coordinates can be obtained.

For example, if the signal intensity of the blue sub-pixel is high compared to the signal intensity of the NIR sub-pixel, one processing condition is that the laser processing is to be performed with second laser beam L2 (blue laser processing), and if the signal intensity of the blue sub-pixel is approximately the same as the signal intensity of the NIR sub-pixel, one processing condition is that the laser processing is to be performed with first laser beam L1 (infrared laser processing).

Next, laser beam intensity is changed based on the adjusted processing conditions (step S56). More specifically, the intensity of first laser beam L1 emitted from first laser oscillator 11 and the intensity of second laser beam L2 emitted from second laser oscillator 12 are changed according to the processing conditions adjusted in step S55.

Next, workpieces 2A and 2B are irradiated by laser beam (step S57). More specifically, first laser beam L1 is emitted from first laser oscillator 11 and irradiates the processing positions of workpieces 2A and 2B at the intensity set in step S56 and/or second laser beam L2 is emitted from second laser oscillator 12 and irradiates the processing positions of workpieces 2A and 2B at the intensity set in step S56.

The laser processing method according to the present embodiment can be performed by following the above steps. In such cases, just like in Embodiment 2 described above, the laser processing may be completed by performing the sequence of steps S52 to S57 only once as described above, or by repeatedly performing the sequence of steps S52 to S57 a plurality of times in real time.

Just like in Embodiment 2 described above, with laser processing device 1D according to the present embodiment, analyzer 30D obtains the signal light from workpieces 2A and 2B and adjusts the processing conditions for workpieces 2A and 2B based on the obtained signal light, and drive controller 20 drives first laser oscillator 11 and second laser oscillator 12 according to the adjusted processing conditions to change the intensity of at least one of first laser beam L1 or second laser beam L2 and irradiate workpieces 2A and 2B with at least one of first laser beam L1 or second laser beam L2.

This achieves the same advantageous effects as in Embodiment 2 described above. Since this allows first laser beam L1 and second laser beam L2 to irradiate the processing positions of workpieces 2A and 2B based on processing conditions suitable for the materials of workpieces 2A and 2B, high quality laser processing with high throughput can be achieved.

In laser processing device 1D according to the present embodiment, analyzer 30D includes image sensor 38 that outputs a two-dimensional image of workpieces 2A and 2B to data processor 31D by receiving the signal light from workpieces 2A and 2B, and data processor 31D adjusts the processing conditions for workpieces 2A and 2B according to the brightness corresponding to the processing positions in the two-dimensional image captured by image sensor 38.

With this configuration, the intensity of signal light at each of the coordinates of the processing positions of workpieces 2A and 2B can be simultaneously analyzed in a two-dimensional plane by comparing and analyzing the brightness of each spectral pixel of the two-dimensional image. This makes it possible to realize a laser processing device that can easily achieve both high processing quality and high throughput.

In laser processing device 1D according to the present embodiment, image sensor 38 may include at least a first pixel provided with a first filter that transmits a third wavelength (λ3) and a second pixel provided with a second filter that transmits a fourth wavelength (λ4). In such cases, data processor 31D may adjust the processing conditions for workpieces 2A and 2B by comparing the pixel signal intensities at the third wavelength and the fourth wavelength of the signal light at the processing positions of workpieces 2A and 2B in the two-dimensional image received by image sensor 38.

This configuration allows the intensity of the signal light with respect to each wavelength to be compared at the spectral pixels corresponding to the coordinates of the processing positions of workpieces 2A and 2B, so that reflection intensities or reflectances at different wavelengths can be analyzed simultaneously in a two-dimensional plane. This makes it possible to realize a laser processing device that can more easily achieve both high processing quality and high throughput.

In such cases, for example, the first filter may be a filter that transmits near-infrared light and the second filter may be a filter that transmits wavelengths of at least part of the visible light range.

This configuration makes it possible to obtain color signals over a wide range of wavelengths, so that material properties can be analyzed simultaneously with high accuracy in a two-dimensional plane when comparing reflection spectrums or reflection intensities. This makes it possible to realize a laser processing device that can more easily achieve both high processing quality and high throughput.

According to the present embodiment, the reflection spectrum in a single Bayer array can be composited by comparing the respective signal intensities of the spectral pixels in the two-dimensional image captured by image sensor 38. For example, if the spectral pixels in the two-dimensional image captured by image sensor 38 are arranged in the array illustrated in FIG. 17, a reflection spectrum as illustrated in FIG. 18 can be obtained for each spectral pixel. In such cases, data processor 31D is connected to a database in which a data set of reflection spectrums is stored, and the reflection spectrums obtained from the spectral pixels of the two-dimensional image captured by image sensor 38 can be compared with the database to analyze the material at the coordinate position of each spectral pixel.

Stated differently, in such cases, data processor 31D may, as in Embodiment 4, compare each of pixel signal intensities at the third wavelength (λ3) and the fourth wavelength (λ4) of the signal light at the processing positions of workpieces 2A and 2B with the data set of reflection spectrums stored in the database, determine which of the materials stored in the database the materials at the coordinates of the processing positions of workpieces 2A and 2B are closest to, and adjust the processing conditions corresponding to the coordinates of the processing positions of workpieces 2A and 2B according to the determined materials.

Since this configuration enables the output of a reflection spectrum for each spectral pixel corresponding to each of the coordinates at the processing positions of workpieces 2A and 2B, the material can be analyzed simultaneously in a two-dimensional plane. This makes it possible to realize a laser processing device that can achieve both high processing quality and high throughput.

Here, the third wavelength (λ3) and the fourth wavelength (λ4) are desirably the same as the wavelength of first laser beam L1 emitted from first laser oscillator 11 and the wavelength of second laser beam L2 emitted from second laser oscillator 12, respectively. With this configuration, it is possible to directly compare the reflectances or the reflection intensities of workpiece 2 at the wavelengths of the laser beams emitted from these laser oscillators. It is thus possible to realize a laser processing device that can perform even higher quality laser processing since the adjustment accuracy of the laser processing conditions is further improved.

Note that the present embodiment is not limited to the example described above where two workpieces 2A or 2B made of only one type of metal material are welded together. For example, a case where two composite materials 2X are welded together, such as Embodiments 1 through 4 described above, can be applied to the present embodiment.

### Embodiment 6

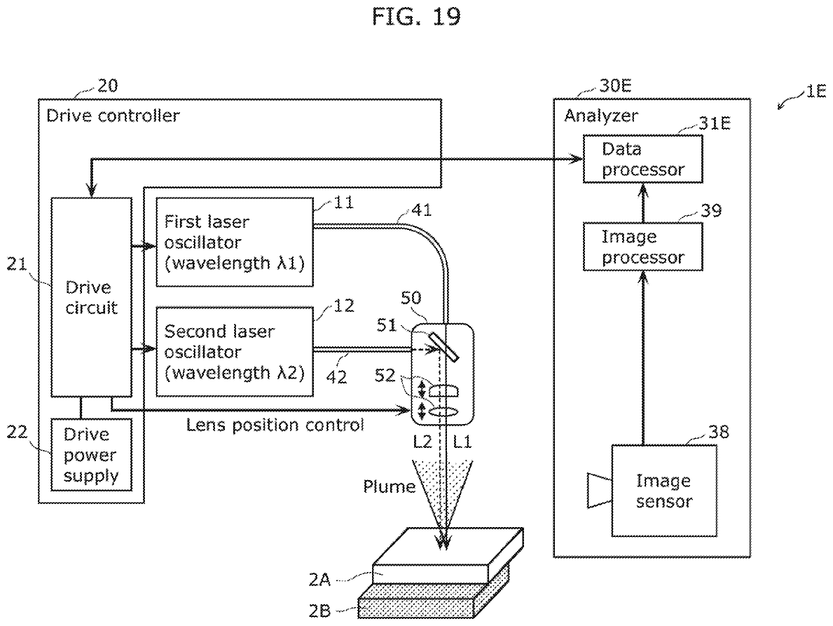

First, the configuration of laser processing device 1E according to Embodiment 6 will be described with reference to FIG. 19. FIG. is a block diagram illustrating the configuration of laser processing device 1E according to Embodiment 6.

As illustrated in FIG. 19, just like laser processing device 1D according to Embodiment 5 described above, laser processing device 1E according to the present embodiment includes first laser oscillator 11, second laser oscillator 12, drive controller 20, and analyzer 30E.

Furthermore, just like laser processing device 1D according to Embodiment 5 described above, laser processing device 1E according to the present embodiment captures and analyzes the signal light from workpiece 2 using image sensor 38. More specifically, analyzer 30E includes data processor 31E, image sensor 38, and image processor 39.

In laser processing device 1D according to Embodiment 5 described above, light source 60 irradiates workpieces 2A and 2B with analysis light, but in laser processing device 1E according to the present embodiment, workpieces 2A and 2B are not irradiated with analysis light.

More specifically, in laser processing device 1E according to the present embodiment, the plume (laser plume) produced during laser processing is analyzed as signal light. Accordingly, in the present embodiment, the signal light from workpieces 2A and 2B is emission light produced during the laser processing as a byproduct of irradiating workpieces 2A and 2B with at least one of first laser beam L1 or second laser beam L2. The plume is a plasma of metallic elements that have risen to high temperature and blown upward during laser processing. The color of the plume varies depending on the material, as in flame color reaction.

Image sensor 38 captures the plume produced during the laser processing in real time to obtain the emission light spectrum of the plume.

Data processor 31E adjusts the processing conditions corresponding to the coordinates of the processing positions of workpieces 2A and 2B based on the emission light spectrum of the plume obtained by image sensor 38. Thus, by measuring the plume, it is possible to select the optimal wavelength for and control the output power of the laser beam for processing, thus improving the processing quality of workpieces 2A and 2B.

FIG. 19 illustrates an example according to the present embodiment in which one workpiece 2A made of a first material (material A) and one workpiece 2B made of a second material (material B) are welded together.

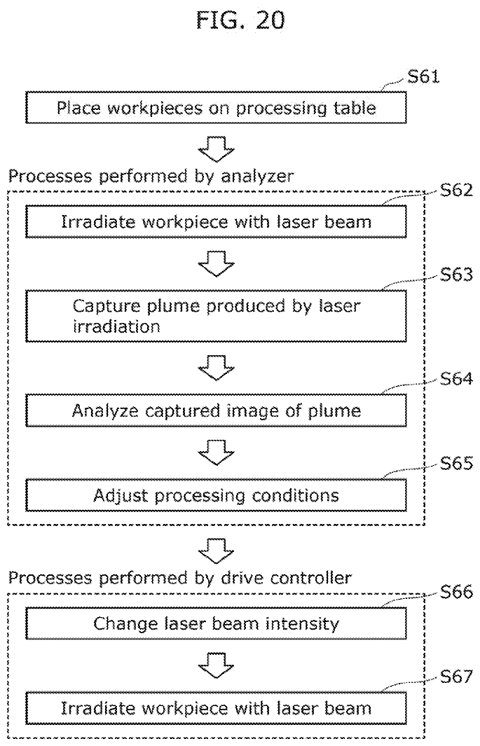

Next, the laser processing method according to the present embodiment that uses laser processing device 1E will be described with reference to FIG. 20. FIG. 20 is a flowchart of the laser processing method according to Embodiment 6.

As illustrated in FIG. 20, first, workpieces 2A and 2B are placed so as to overlap on processing table 3 (step S61). Step S61 is the same as step S21 in the laser processing method according to Embodiment 2 described above.

Next, workpiece 2A or 2B is irradiated by laser beam (step S62). More specifically, since workpiece 2A is placed on top of workpiece 2B, the processing position of workpiece 2A is irradiated with at least one of first laser beam L1 or second laser beam L2 as the laser beam for processing.

Next, the plume produced by the laser irradiation is captured by image sensor 38 (step S63). More specifically, the plume produced when irradiating the processing position of workpieces 2A and 2B with at least one of first laser beam L1 and second laser beam L2 as the laser beam for processing is captured by image sensor 38 as the signal light from workpiece 2A or 2B, thereby obtaining the emission light spectrum of the plume.

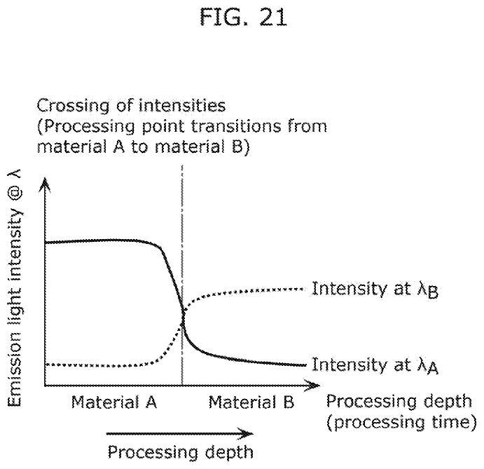

In such cases, for example, as the processing depth increases by the laser processing (i.e., as the processing time elapses), image sensor 38 can obtain the processing depth (or processing time) dependence of the emission light intensity at a particular wavelength contained in the plume, as illustrated in FIG. 21.

Next, the captured image of the plume is analyzed (step S64). More specifically, the emission light spectrum of the plume captured by image sensor 38 is compared with a database (not illustrated) storing a data set of emission light spectrums for respective materials, and determines which of the materials stored in the database the material of the workpiece being laser processed is closest to.

As the depth of the laser processing increases and, as illustrated in FIG. 21, the emission light intensities of the first material (material A) and the second material (material B) cross, this indicates that the workpiece that is being processed switches, at the cross point of the emission light intensities, from workpiece 2A of the first material (material A) to workpiece 2B of the second material (material B).

Next, the processing conditions for the workpiece are adjusted according to the analysis result of step S64 (step S65). More specifically, among first laser beam L1 and second laser beam L2, the laser beam with the more suitable wavelength for the material determined in step S64 is selected.

Next, laser beam intensity is changed based on the adjusted processing conditions (step S66). More specifically, the intensity of first laser beam L1 emitted from first laser oscillator 11 and the intensity of second laser beam L2 emitted from second laser oscillator 12 are changed according to the processing conditions adjusted in step S65.

Next, the workpiece is irradiated by laser beam (step S67). More specifically, first laser beam L1 is emitted from first laser oscillator 11 and irradiates the processing position of workpiece 2 at the intensity set in step S66 and/or second laser beam L2 is emitted from second laser oscillator 12 and irradiates the processing position of workpiece 2 at the intensity set in step S66.

The laser processing method according to the present embodiment can be performed by following the above steps.

Just like in Embodiment 5 described above, with laser processing device 1E according to the present embodiment, analyzer 30E obtains the signal light from workpieces 2A and 2B and adjusts the processing conditions for workpieces 2A and 2B based on the obtained signal light, and drive controller 20 drives first laser oscillator 11 and second laser oscillator 12 according to the adjusted processing conditions to change the intensity of at least one of first laser beam L1 or second laser beam L2 and irradiate workpieces 2A and 2B with at least one of first laser beam L1 or second laser beam L2.

This achieves the same advantageous effects as in Embodiment 5 described above. Since this allows first laser beam L1 and second laser beam L2 to irradiate the processing position of workpieces 2A and 2B based on processing conditions suitable for the materials of workpieces 2A and 2B, high quality laser processing with high throughput can be achieved.

Moreover, in laser processing device 1E according to the present embodiment, the signal light from workpieces 2A and 2B is emission light produced during the laser processing as a byproduct of irradiating workpiece 2A or 2B with at least one of first laser beam L1 or second laser beam L2.

With this configuration, since the material of workpiece 2A or 2B can be identified by the plume produced during laser processing of workpieces 2A and 2B, the laser beam that is most suitable for the material can be selected for processing. Stated differently, the materials of workpieces 2A and 2B can be identified and the wavelength of the laser beam to be used for processing can be selected in real time. This makes it possible to adjust the processing conditions for the workpiece while performing the laser processing since the material of the workpiece can be analyzed while performing the laser processing. Accordingly, this makes it possible to realize a laser processing device that can achieve both high processing quality and high throughput.

Although an emission light spectrum of the plume is exemplified as being obtained using image sensor 38 in the present embodiment, the present disclosure is not limited to this example. A spectrometer may be used instead of image sensor 38. In such cases, analyzer 30E may include a spectrometer that separates the plume (emission light) and a data processor that outputs an emission light spectrum of the plume, and the data processor may adjust the processing conditions corresponding to the coordinates of the processing position of the workpiece based on the emission light spectrum of the data processor.

This configuration also makes it possible to obtain a material-specific emission light spectrum, which improves the accuracy of the analysis of the material properties or chemical composition of the material at the coordinates of the processing position of the workpiece, and improves the adjustment accuracy of the laser processing conditions, which depend on the material. With this, it is possible to realize a laser processing device that can perform high quality laser processing.

### Variations

The laser processing device, etc., according to the present disclosure has been described above based on embodiments, but the present disclosure is not limited to the above embodiments.

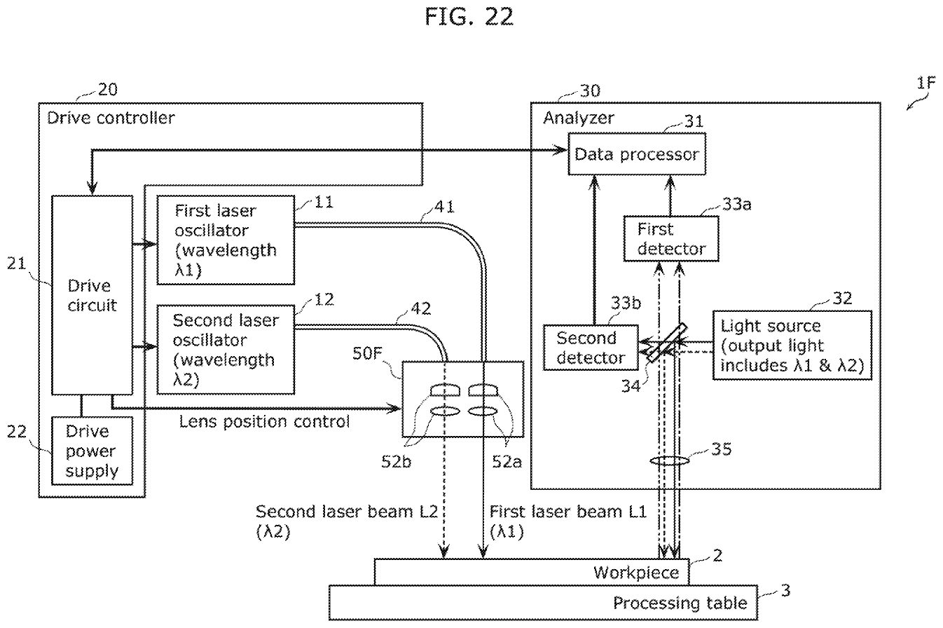

For example, in Embodiments 2 through 6 described above, first laser beam L1 emitted from first laser oscillator 11 and second laser beam L2 emitted from second laser oscillator 12 are aligned to be coaxial on the same optical axis via optical system 50, which is a single condensing optical system comprising half mirror 51 and lens 52, and then irradiate the workpiece, but the present disclosure is not limited to this example. For example, as in laser processing device 1F illustrated in FIG. 22, first laser beam L1 emitted from first laser oscillator 11 and second laser beam L2 emitted from second laser oscillator 12 may irradiate the workpiece on different optical axes via optical system 50F, which includes two separate condensing optical systems, namely first lens group 52a and second lens group 52b.

In Embodiment 1 described above, light source 32 includes a first light source that emits light including the first wavelength (λ1), which is the peak wavelength of first laser beam L1, and a second light source that emits light including the second wavelength (λ2), which is the peak wavelength of second laser beam L2, but the present disclosure is not limited to this example. For example, light source 32 may include a first light source that emits light including a third wavelength (λ3) that is different than the first wavelength (λ1) and the second wavelength (λ2), and a second light source that emits light including a fourth wavelength (λ4) that is different than the first wavelength (λ1), the second wavelength (λ2), and the third wavelength (λ3). In such cases, the first light source of light source 32 emits light having a peak wavelength of the third wavelength (λ3) as the first analysis light, and the second light source of light source 32 emits light having a peak wavelength of the fourth wavelength (λ4) as the second analysis light. The third wavelength (λ3) and the fourth wavelength (λ4) are desirably in a range from ultraviolet light to near-infrared light. This is because changes in absorption and reflection spectrums of metals and other materials occur mostly in the ultraviolet to near-infrared range. One of the third wavelength (λ3) and the fourth wavelength (λ4) may be a wavelength in the visible light range or shorter, and the other may be a wavelength in the visible light range or longer. This is because if the third wavelength (λ3) and the fourth wavelength (λ4) are close to each other, it will be difficult to identify the material.

In Embodiments 1 through 6 described above, two laser oscillators are used for processing, namely first laser oscillator 11 and second laser oscillator 12, but the present disclosure is not limited to this example. For example, three or more laser oscillators may be used for processing. In other words, the wavelength may be selected and the output power may be controlled for three or more laser beams.

In Embodiments 1 through 6 described above, it is not necessary to create pre-prepared recipes such as those described in FIG. 1 and FIG. 2 in advance of the laser processing, but such pre-prepared recipes may be used in combination in Embodiments 1 through 6 described above.

Although metal-to-metal laser processing is used as an example in Embodiments 1 through 6, the present disclosure is not limited to this example. For example, the present disclosure is applicable to metal-to-resin laser processing as well as resin-to-resin laser processing. The present disclosure is applicable to laser processing of various materials and is not limited to metals and resins. The present disclosure is particularly suitable for laser processing of dissimilar materials with different absorption rates of light.

Various modifications of the above embodiments that may be conceived by those skilled in the art, as well as embodiments resulting from arbitrary combinations of elements and functions from different embodiments that do not depart from the essence of the present disclosure are included the present disclosure.

### INDUSTRIAL APPLICABILITY

The techniques of the present disclosure are applicable to, for example, laser processing devices that process a workpiece by laser irradiation.

1. A laser processing device that processes an object using a laser beam, the laser processing device comprising:
a first laser oscillator that emits a first laser beam having a peak wavelength of a first wavelength;
a second laser oscillator that emits a second laser beam having a peak wavelength of a second wavelength different than the first wavelength;
a drive controller that drives each of the first laser oscillator and the second laser oscillator; and
an analyzer that obtains signal light from the object and adjusts one or more processing conditions for the object based on the signal light obtained, wherein
the drive controller drives the first laser oscillator and the second laser oscillator according to the one or more processing conditions to change an intensity of at least one of the first laser beam or the second laser beam and irradiate the object with at least one of the first laser beam or the second laser beam.

2. The laser processing device according to claim 1, wherein
the drive controller drives the first laser oscillator and the second laser oscillator according to the one or more processing conditions to cause the first laser oscillator and the second laser oscillator to emit one of the first laser beam and the second laser beam and not emit an other of the first laser beam and the second laser beam.

3. The laser processing device according to claim 1, wherein
the analyzer includes a data processor that analyzes the signal light.

4. The laser processing device according to claim 3, wherein
the analyzer adjusts the one or more processing conditions corresponding to coordinates of a processing position of the object, the coordinates being obtained when the signal light is obtained, and
the drive controller drives the first laser oscillator and the second laser oscillator according to the one or more processing conditions to cause the first laser oscillator and the second laser oscillator to irradiate the object with at least one of the first laser beam or the second laser beam based on the coordinates of the processing position.

5. The laser processing device according to claim 4, wherein
the data processor adjusts the one or more processing conditions corresponding to the coordinates of the processing position of the object based on the signal light.

6. The laser processing device according to claim 4, wherein
the analyzer includes:
a light source that emits analysis light; and
an optical system that irradiates the processing position of the object with the analysis light, and
the signal light is at least part of the analysis light reflected by a surface of the object.

7. The laser processing device according to claim 6, wherein
the analysis light includes first analysis light of the first wavelength and second analysis light of the second wavelength,
the signal light includes first signal light and second signal light, the first signal light being the first analysis light that irradiates and is reflected by the object, the second signal light being the second analysis light that irradiates and is reflected by the object, and
the data processor adjusts the one or more processing conditions by comparing an intensity of the first signal light with an intensity of the second signal light at the coordinates of the processing position of the object, or comparing a reflectance at the first wavelength with a reflectance at the second wavelength at the coordinates of the processing position of the object.

8. The laser processing device according to claim 6, wherein
the analysis light includes a wavelength of at least one of the first laser beam or the second laser beam.

9. The laser processing device according to claim 8, wherein
the analysis light is produced by guiding part of at least one of the first laser beam or the second laser beam.

10. The laser processing device according to claim 6, wherein
the data processor adjusts the one or more processing conditions corresponding to the coordinates of the processing position of the object by analyzing a reflection intensity or a reflectance of the analysis light based on an intensity of the signal light and associating the coordinates of the processing position of the object with the reflection intensity or the reflectance.

11. The laser processing device according to claim 6, wherein
the analyzer includes a first detector and a second detector,
the first detector receives the signal light, the signal light being the analysis light reflected by the object,
the second detector receives at least part of the analysis light, and
the data processor corrects an intensity of the signal light received by the first detector with an intensity of the analysis light received by the second detector.

12. The laser processing device according to claim 4, wherein
the analyzer includes a spectrometer that separates analysis light,
the analysis light separated by the spectrometer irradiates the processing position of the object,
the analyzer includes a detector that measures the signal light to measure a reflection spectrum, the signal light being the analysis light separated by the spectrometer and reflected by a surface of the object, the reflection spectrum indicating a wavelength dependence of an intensity or a reflectance of the signal light, and
the data processor adjusts the one or more processing conditions corresponding to the coordinates of the processing position of the object based on the reflection spectrum.

13. The laser processing device according to claim 4, wherein
the analyzer includes:
a spectrometer that separates the signal light; and
a detector that measures the signal light separated by the spectrometer to measure a reflection spectrum indicating a wavelength dependence of an intensity or a reflectance of the signal light, and
the data processor adjusts the one or more processing conditions corresponding to the coordinates of the processing position of the object based on the reflection spectrum.

14. The laser processing device according to claim 13, wherein
the data processor is connected to a database,
the database stores a data set of reflection spectrums for respective materials, and
the data processor:
compares the reflection spectrum obtained from the signal light with the data set of the reflection spectrums stored in the database;
determines which of the materials stored in the database a material at the coordinates of the processing position of the object is closest to; and
adjusts the one or more processing conditions corresponding to the coordinates of the processing position of the object according to the material determined.

15. The laser processing device according to claim 6, wherein
the light source of the analysis light is a laser oscillator or a light-emitting diode (LED).

16. The laser processing device according to claim 6, wherein
the analysis light is monochromatized by a spectrometer or a filter that transmits a specific wavelength band.

17. The laser processing device according to claim 1, wherein
the analyzer includes a solid-state imaging element including a two-dimensional array of pixels that receive light,
the solid-state imaging element outputs a two-dimensional image of the object to a data processor by receiving the signal light, and
the data processor adjusts the one or more processing conditions for the object according to a brightness corresponding to a processing position of the object in the two-dimensional image.

18. The laser processing device according to claim 17, wherein
the solid-state imaging element includes at least a first filter that transmits a third wavelength, a first pixel provided with the first filter, a second filter that transmits a fourth wavelength, and a second pixel provided with the second filter, and
the data processor adjusts the one or more processing conditions for the object by comparing pixel signal intensities at the first wavelength and the second wavelength of the signal light at the processing position of the object in the two-dimensional image generated by the solid-state imaging element.

19. The laser processing device according to claim 18, wherein
the first filter transmits near-infrared light, and
the second filter transmits wavelengths of at least part of a visible light range.

20. The laser processing device according to claim 18, wherein
the data processor:
compares each of pixel signal intensities at the third wavelength and the fourth wavelength of the signal light at the processing position with a data set of reflection spectrums stored in a database;
determines which of materials stored in the database a material at coordinates of the processing position of the object is closest to; and
adjusts the one or more processing conditions corresponding to the coordinates of the processing position of the object according to the material determined.

21. The laser processing device according to claim 1, wherein
the signal light is emission light produced during the processing as a byproduct of irradiating the object with at least one of the first laser beam or the second laser beam.

22. The laser processing device according to claim 21, wherein
the analyzer includes a spectrometer that separates the emission light and a data processor that outputs an emission light spectrum of the emission light, and
the data processor adjusts the one or more processing conditions corresponding to coordinates of a processing position of the object based on the emission light spectrum.
